(19) United States
(12) Patent Application Publication
(10) Pub. No.: US 2014/0243073 A1
(43) Pub. Date: Aug. 28, 2014

(54) PRODUCT-CENTRIC GAMING PLATFORM

(71) Applicants: NIKOLAOS PAPACHRISTOS, ATHENS (GR); VISSARION LAKAFOSIS, ATHENS (GR)

(72) Inventors: NIKOLAOS PAPACHRISTOS, ATHENS (GR); VISSARION LAKAFOSIS, ATHENS (GR)

(21) Appl. No.: 14/073,763

(22) Filed: Nov. 6, 2013

Related U.S. Application Data
(60) Provisional application No. 61/768,457, filed on Feb. 23, 2013.

(51) Int. Cl. G07F 17/32

(52) U.S. Cl. CPC G07F 17/3225
USPC 463/25; 463/42

(57) ABSTRACT

The present disclosure describes a product-centric gaming solution. A client device, as part of a number selection wagering competition, receives, from a server-based gaming platform, a list of product offerings for a player to choose from. The selected product offerings and the corresponding cash equivalent cost associated with a player number selection is displayed to the player. The player selected product offering is communicated to the server-based gaming platform. From there, a number-selection pattern comprised of a set of numbers is received from the server-based gaming platform. Player number selections are transmitted to the server-based gaming platform. The player is notified of player number selections are associated with reserved numbers, either before or after selection is made. Finally, at some point during the competition, the player's account is debited an amount equal to the cash equivalent cost of each number selected times the number of numbers selected. Winning numbers are those that match the two digit decimal value of an a priori determined association to a specific stock market index.

### RELATED APPLICATIONS

This application claims the benefit of U.S. Provisional Application No. 61/768,457, filed on Feb. 23, 2013, commonly owned and assigned to the same assignee hereof.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The field of the invention relates generally to games of chance, and more particularly, to systems and methods for rewarding players of lottery-based games, casino-based games, and the like games of chance.

### BACKGROUND

Electronic video Keno is a known game where the player picks from one to ten numbers from a field of eighty numbers. The desired numbers are selected usually through touch-screen technology and are indicated on a grid to visually display the numbers selected. When the game begins, the processor for the electronic game randomly selects twenty numbers from the field of eighty numbers, 1-80, and the selected numbers are likewise displayed by the machine. There is a displayed paytable for each game and, depending on how many numbers of the player selected numbers match with the outcome numbers selected by the machine's processor, the player wins an amount based on the paytable or loses their wager. This type of “regular” ticket is commonly played for a given number of specific numbers and is referred to by the number of “spots” picked, such as, a “Four Spot” ticket when four numbers are picked by the player, a “Six Spot” when the player picks six numbers, and so on for any group of numbers from one to ten.

Electronic Keno has proved to be a wildly successful concept. The general concept has been extended and applied in various forms to different methodologies. Some of these are more successful than others. However, there is a continuing interest on the part of online casinos, regular casinos, and online gaming sites to be able to offer new and fresh games, and if possible, utilizing commonly understood KENO concepts.

KENO and other number-centric gaming platforms rely on random number generators to generate winning results. The degree to which random number generators are actually random is a point of concern for many players and potential players of games of chance. In this regard, there is a legitimate need by casinos, online gambling companies, and be able to convince people that the algorithms and the results are truly random. In fact, the perception by many people that such games may be easily manipulated, and thus not truly random, also acts as a deterrent for many merchants and advertisers to promote their products through such games.

### SUMMARY

The present disclosure describes a product-centric gaming solution. A client device, as part of a number selection wagering competition, receives, from a server-based gaming platform, a list of product offerings for a player to choose from. The selected product offerings and the corresponding cash equivalent cost associated with a player number selection is displayed to the player. The player selected product offering is communicated to the server-based gaming platform. From there, a number-selection pattern comprised of a set of numbers, is received from the server-based gaming platform. Player number selections are transmitted to the server-based gaming platform. The player is notified of player number selections are associated with reserved numbers, either before or after selection is made. Finally, at some point during the competition, the player's account is debited an amount equal to the cash equivalent cost of each number selected times the number of numbers selected. Winning numbers are those that match the two digit decimal value of a priori determined association to a specific stock market index.

In another aspect, a question may be employed as a precondition to wagering. A wrong question may or may not result in loss of points, but is necessary to be able to play. The requirement that a question be correctly answered as a prerequisite to participation renders the activities as skill-based activities and in many jurisdictions, this may be sufficient in overcoming gambling and like type wagering regulations and restrictions. In addition, questions can be used to collect survey type marketing information and/or better data mining.

In another aspect, the product centric nature of the proposed solution is a marketing tool offered for free to visitors to a website as a means to sign them up as members. Once signed up as members, they may be allowed to bid (without wagering points/credits/cash to win the prize or prizes in a given competition, in exchange for agreeing to periodically visiting the site, making a minimum number of purchases, or any like incentive. In conjunction, with such incentives, questions can be narrowly tailored to better understand the member's shopping or personal habits, and tailor advertising to them and, in this way, tailor the product offerings pitched to returning members so as to further encourage them to return to the site. In the case where the site is also a major merchant, such as AMAZON or LINKSHARE, the same merchant can use the game as a way to attract eyeballs more efficiently to its site.

In one embodiment, players select as many numbers as they like from the set of numbers available to choose from (typically 100). Once a number is picked, it becomes automatically unavailable to later-to-select players. The prize may be a cash prize or a product offering. In one aspect, the player selects a stock market of choice at the time of selecting a desired number or numbers, and may select different stock markets indexes for different numbers, in the same competition.

In one aspect, the number-selection centric gaming platform can operate as a traditional cash reward KENO game. In this scenario, a player may be required to match multiple numbers to multiple stock market indexes. In a related scenario, index values can be collected on a predefined (e.g., five minute) time intervals during a period active market trading activities.

In another embodiment, the same number may be selected more than one time and by more than one player simultaneously during a single competition. This will result in multiple winners being entitled to the same prize. A tie-breaker feature may be employed to deal with this eventuality, else multiple winners are announced.

The present disclosure further describes a number-selection centric gaming platform. For a given competition, players select as many numbers as they like from the set of numbers available to choose from (typically 100). Once a number is picked, it becomes automatically unavailable to later-to-select players. Numbers are selected randomly based on system or user selection of a particular stock market index. Improved random number generation is realized by using the first and second decimal place values of a stock market index value at close. The prize may be a cash prize or a product offering. In one aspect, the player selects a stock market of choice at the time of selecting a desired number or numbers, and may select different stock markets indexes for different numbers, in the same competition.

In one aspect, the number-selection centric gaming platform can operate as a traditional cash reward KENO game. In this scenario, a player may be required to match multiple numbers to multiple stock market indexes. In a related scenario, index values can be collected on a predefined (e.g., five minute) time intervals during a period active market trading activities.

The present disclosure also describes a random number generator apparatus and method configured to feed winning number selections to a number-selection centric wagering platform or device which in turn is adapted to use the number selections to identify winning events in a game of chance executing locally. Numbers are selected randomly based on system or user selection of a particular stock market index. Improved random number generation is realized by using the first and second decimal place values of a stock market index value at close. The prize could be cash or a product offering. In one aspect, the player selects a stock market of choice at the time of selecting a desired number or numbers, and may select different stock markets indexes for different numbers, in the same competition.

The present disclosure describes a product-centric gaming platform that brings together buyers with merchants interested in quickly selling off a stock of product offerings. The platform creates a gaming environment around a merchant's product offering. A merchant logs into the platform and uploads a description of the product offering. This information is used to determine the number of credits/points/cash that the player customer will be required to wager for the opportunity to try and win. Winning involves a player matching his selected number to the close value of a stock market index.

For a given competition, players select as many numbers as they like from the set of numbers available to choose from (typically 100). Once a number is picked, it becomes automatically unavailable to later-to-select players. Numbers are selected randomly based on system or user selection of a particular stock market index. Improved random number generation is realized by using the first and second decimal place values of a stock market index value at close. The prize may be a cash prize or a product offering.

In one aspect, the player selects a stock market of choice at the time of selecting a desired number or numbers, and may select different stock markets indexes for different numbers, in the same competition. The wagering platform may be configured as B2B, C2B, B2C, and/or C2C. There is no reserve price.

In another aspect, the wagering platform is merely a technology solution provider. In this regard, the wagering platform charges a commission for buying credits/points, converting point/credits to/from cash, and/or transferring points/credits between members.

### BRIEF DESCRIPTION OF THE DRAWINGS

FIG. 1 illustrates a block diagram of a web-based platform (WINFUZZ gaming system) for one embodiment of the present invention.

FIG. 2 shows an example HOME screen of WINFUZZ.

FIG. 3 is served up by server in response to a visitor to the site clicking on the “store” tab.

FIG. 4 is served up by server 201 in response to a visitor to the site clicking on results tab.

FIGS. 5A to 5D are a representative set of continuous page content showing a representative set of Terms and Conditions in accordance with an exemplary embodiment.

FIG. 6 shows a table of indexes to be used as player choice's of algorithm to be used for random number generation of winning number.

FIG. 7 is a representative single line of numbers (50 through 59) from the list comprised of numbers 0 through 99.

FIG. 8 is a close up result of an index, with the index decimal part shown blown up.

FIGS. 9 to 16 show a representative set of slides from a video presentation available on the WINFUZZ site.

FIG. 17 is an example user interface (UI) screen 1000 showing the process of adding points. This screen may be accessible from, for example, clicking on the “BUY CREDITS” button 150 shown on the HOME page 100 in FIG. 2.

FIG. 18 is an example UI screen 1100 for the registration of new members. Only registered members qualify to play and buy points.

FIG. 19 is an example UI screen 1200 of a registered game player's gaming activity (in table form 1210) for a given period of play.

FIG. 20 is an example UI screen 1300 of a registered game player's purchase activity shown in table form 1310.

FIG. 21 is an example UI screen 1400 showing six new products available for wagering when player selects and clicks on the Hi-Tech tab 1410. The game player has hovered over and is about to select the LINKSYS ROUTER product 1420 to play for.

FIG. 22 is an example UI screen 1500 showing a pop-up 1510 automatically generated to show more details for the selected product in FIG. 22.

FIG. 23 is an example UI screen 1600 showing a pop up 1610 generated in response to the player having clicked on the “participate” icon and is invited, by way of a new pop-up, to confirm that he will be required to correctly answer a question as a precondition to being able to wager on the item.

FIG. 24 is an example UI screen showing that a player, before answering any question, is next taken to a new UI where he is instructed to select an index from index table to be used as the random number generation variable that will determine if a selected number will ultimately have won or lost.

FIG. 25 is a UI screen showing player selections.

FIG. 26 is a UI screen of a pop up that is generated by the server in response to a different (second) player wanting to buy a different product (EXTERNAL HD 3TB).

FIG. 27 is a UI screen of a further pop up confirming the correct answer and locking in the numbers previously selected by the second player.

FIG. 28 is a UI screen of a follow up number entry by the second player seeking to add three new possible winning numbers (56, 57, 58) (not shown).

FIG. 29 is a UI screen generated by the server in response to the right answer, and showing subset of numbers 34, 35, 44, 45, 56, 57, and 58 all now being designated as reserved (red color).

FIG. 30 is a UI screen of a pop up generated in response to the same player wanting to add the further three additional numbers 56, 57, and 58. This time, a different question is presented which the second player gets wrong).

FIG. 31 is a UI screen which takes back the second player to the number-selection table to allow selection of new numbers and a new question.

FIG. 32 is a high level operational flow diagram of a routine running at the server-based gaming platform 199, in accordance with an exemplary embodiment.

FIG. 33 is a further high level operational flow diagram of a routine running in a client device, in accordance with an exemplary embodiment.

FIG. 34 is a routine for generating and delivering the decimal values of an example stock market index to a platform.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

For clarification purposes, the words “user”, “player”, “wagerer”, “customer”, “member”, “participant”, “bidder”, “client”, “winner”, and “gamer”, are all intended as referring to the same person, or class of persons.

Likewise, the words “product” or “products” are meant at all times to include service offerings, in addition to products, and cash or cash equivalent offerings in some cases.

Further, the words “client” and “client device” are meant to be used interchangeably.

In addition, unless specifically referring to “points”, “credits”, or “cash”, aforementioned terms are intended to refer to “cash or cash equivalents”, or simply “cash equivalents”.

The present disclosure describes a product-centric gaming solution. A client device, as part of a number selection wagering competition, receives, from a server-based gaming platform, a list of product offerings for a player to choose from. The selected product offerings and the corresponding cash equivalent cost associated with a player number selection is displayed to the player. The player selected product offering is communicated to the server-based gaming platform. From there, a number-selection pattern comprised of a set of numbers, is received from the server-based gaming platform. Player number selections are transmitted to the server-based gaming platform. The player is notified of player number selections are associated with reserved numbers, either before or after selection is made. Finally, at some point during the competition, the player's account is debited an amount equal to the cash equivalent cost of each number selected times the number of numbers selected. Winning numbers are those that match the two digit decimal value of a priori determined association to a specific stock market index.

In another aspect, a question may be employed as a precondition to wagering. A wrong question may or may not result in loss of points, but is necessary to be able to play. The requirement that a question be correctly answered as a prerequisite to participation renders the activities as skill-based activities and in many jurisdictions, this may be sufficient in overcoming gambling and like type wagering regulations and restrictions. In addition, questions can be used to collect survey type marketing information and/or better data mining.

In another aspect, the product centric nature of the proposed solution is a marketing tool offered for free to visitors to a website as a means to sign them up as members. Once signed up as members, they may be allowed to bid (without wagering points/credits/cash to win the prize or prizes in a given competition, in exchange for agreeing to periodically visiting the site, making a minimum number of purchases, or any like incentive. In conjunction, with such incentives, questions can be narrowly tailored to better understand the member's shopping or personal habits, and tailor advertising to them and, in this way, tailor the product offerings pitched to returning members so as to further encourage them to return to the site. In the case where the site is also a major merchant, such as AMAZON or LINKSHARE, the same merchant can use the game as a way to attract eyeballs more efficiently to its site,

Players may select as many numbers as they like from the set of numbers available to choose from (typically 100). Once a number is picked, it becomes automatically unavailable to later-to-select players. Numbers are selected randomly based on system or user selection of a particular stock market index. Improved random number generation is realized by using the first and second decimal place values of a stock market index value at close. The prize may be a cash prize or a product offering. In one aspect, the player selects a stock market of choice at the time of selecting a desired number or numbers, and may select different stock markets indexes for different numbers, in the same competition.

Stock Market Index as RNG

The idea of random number generators (RNGs) using stock market index information to generate random numbers is generally known. The notion of using such generators in connection with the creation of number generation for game of chance type applications is also seen discussed in the literature. In fact, the gaming community and game developers are generally adverse to using solutions that are based on stock market information results for RNG.

The fact that human activity is to some extent objectively not “random” is a major deterrent by game developers using any RNG that relies on human or animal behavior (horse race results, for example).

With that said, players on the other hand, tend to trust human and animal derived RNG solutions (engines).

Applicant has discovered that the first and second decimal places of a stock market index, at close, but also throughout a period of active market activity, would actually make an excellent RNG for games of chance, for a number of reasons, including the fact that:

(i) because a two digit decimal combination represents a number from 0 to 99, the number itself can serve as the output of RNG, without more; and

(ii) in most large, in terms of trading volume, stock market indexes, the rate of change is statistically extremely high and results in high, in terms of randomness efficiency, reliability and variability; as such casino, gaming regulator, and other industry entity concerns over a player being able to control human behavior, is determined to be statistically near impossible.

Given these facts, and the psychology of player preference and confidence in a stock market index, versus a black-box algorithm, the chicken and egg problem is overcome.

As such, it is believed that the use of decimal digit results in this way and in the present context of employing same to match the decimal combination to a player selected number from a range of numbers—which is the same or no greater than 100 numbers (00-99)—is novel.

By combining information received from multiple stock indexes simultaneously, and not exclusively at close of the markets, the number-selection centric gaming platform can operate as a traditional cash reward KENO game. In one example, a player wanting to create a KENO score card selecting more than one number to win, need select the numbers that he/she believes will win in a traditional or classic sense of picking numbers. The player will be able to compare these numbers to the corresponding stock market index which he had to have designated or chosen at time of number selection.

In other words, players are required to match multiple numbers to multiple stock market indexes.

In a related scenario, index values can be collected on a predefined (e.g., five minute) time intervals during a period active market trading activities.

In another embodiment, the same number may be selected more than one time and by more than one player simultaneously during a single competition. This will result in multiple winners being entitled to the same prize. A tie-breaker feature may be employed to deal with this eventuality, else multiple winners are announced.

The present disclosure further describes a number-selection centric gaming platform. For a given competition, players select as many numbers as they like from the set of numbers available to choose from (typically 100). Once a number is picked, it becomes automatically unavailable to later-to-select players. Numbers are selected randomly based on system or user selection of a particular stock market index. Improved random number generation is realized by using the first and second decimal place values of a stock market index value at close. The prize may be a cash prize or a product offering. In one aspect, the player selects a stock market of choice at the time of selecting a desired number or numbers, and may select different stock markets indexes for different numbers, in the same competition.

In one aspect, the number-selection centric gaming platform can operate as a traditional cash reward KENO game. In this scenario, a player may be required to match multiple numbers to multiple stock market indexes. In a related scenario, index values can be collected on a predefined (e.g., five minute) time intervals during a period active market trading activities.

The present disclosure also describes a random number generator apparatus and method configured to feed winning number selections to a number-selection centric wagering platform or device which in turn is adapted to use the number selections to identify winning events in a game of chance executing locally. Numbers are selected randomly based on system or user selection of a particular stock market index. Improved random number generation is realized by using the first and second decimal place values of a stock market index value at close. The prize could be cash or a product offering. In one aspect, the player selects a stock market of choice at the time of selecting a desired number or numbers, and may select different stock markets indexes for different numbers, in the same competition.

The present disclosure describes a product-centric gaming platform that brings together buyers with merchants interested in quickly selling off a stock of product offerings. The platform creates a gaming environment around a merchant's product offering. A merchant logs into the platform and uploads a description of the product offering. This information is used to determine the number of credits/points/cash that the player customer will be required to wager for the opportunity to try and win. Winning involves a player matching his selected number to the close value of a stock market index.

For a given competition, players select as many numbers as they like from the set of numbers available to choose from (typically 100). Once a number is picked, it becomes automatically unavailable to later-to-select players. Numbers are selected randomly based on system or user selection of a particular stock market index. Improved random number generation is realized by using the first and second decimal place values of a stock market index value at close. The prize may be a cash prize or a product offering.

In one aspect, the player selects a stock market of choice at the time of selecting a desired number or numbers, and may select different stock markets indexes for different numbers, in the same competition. The wagering platform may be configured as B2B, C2B, B2C, and/or C2C. There is no reserve price.

In another aspect, the wagering platform is merely a technology solution provider. In this regard, the wagering platform charges a commission for buying credits/points, converting point/credits to/from cash, and/or transferring points/credits among members.

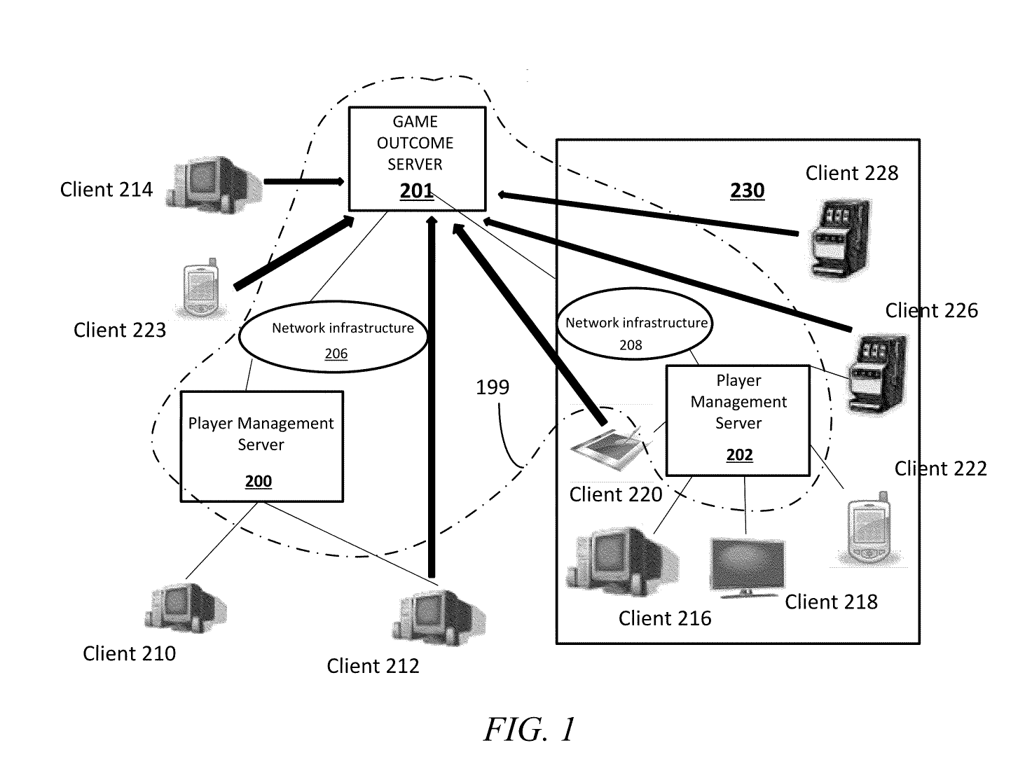

FIG. 1 illustrates a block diagram of a server-based gaming platform 199 coupled to a plurality of client devices 210, 212, 214, 216, 218, 220, 222, 224, 226 and 228 to form a gaming system in accordance with one embodiment of the present invention. Server-based gaming platform 199 may provide wager-based gaming services on many but also quite different types of client devices. The gaming system 199 may comprise a game outcome server 201, player management servers 200 and 202, network infrastructure, such as 206 and 208, and clients 210, 212, 214, 216, 218, 220, 222, 224, 226 and 228. A number of different remote servers 200, 201 or 202 may be utilized to a variety of complementary support activities as further described below.

The clients in web-based platform 199 provide an interface that allows a user to access WINFUZZ™, a web-based game. To provide the interface, the client may at least include a display device for viewing the game and input mechanism for making choices related to the play of a game. For example, the input mechanism may allow a player to select a number of actions to be shown and described below, and which include instructions on how to play WINFUZZ™.

Some examples of input mechanisms include but are not limited to a mouse, keyboard, buttons on a button panel and a touch screen.

Many different types of clients may be used in the gaming system 200. Some examples of clients include but are not limited to personal computers, 210, 212 and 214, cell phones 222 and 224, a tablet computer 218, a PDA 220, casino-type gaming machines 226 and 228 and a television set-top box or SMART-TV 216.

During game play, the clients may be located in a monitored and relatively secure environment, such as a casino environment 230, or in an unmonitored environment, such as a user's home. The casino environment 230 may include locations associated with a casino where game play is allowed. Nevertheless, the clients of the present invention may be used in other environments, such as stores, restaurants, bars, racetracks, sports books and other venues where game play is allowed.

The network infrastructure, such as but not limited to 206 and 208, that allow the clients and servers to communicate with one another may comprise various combinations of wireless and wired communication links. Also, various wireless and wired communication protocols may be employed over these links as is appropriate for the devices that are communicating and the type of communication link that is being utilized for the communication. The protocols that are utilized may be of a proprietary or non-proprietary nature. The network infrastructures 206 and 208 may utilize communication links provided by wide-area networks, such as the Internet, a wide area progressive jackpot network, a Wi-Fi network or a cell phone network and/or local area networks, such as a communication schema provided within a casino.

In one embodiment, the player management servers 200 and 202 may allow a remote client to provide game play of games where a monetary balance is adjusted based upon the outcome of the game. To enable the game play, the player management servers, 200 and 202, may be operable to provide an account with a balance of funds that a player may use to play games. As part of the account management, the player management servers may be operable to allow funds to be deposited and transferred from the account. In a particular embodiment, the transfers of funds into and out of the account may be performed electronically. The electronic fund transfers may involve credit cards, debit cards, bank accounts, wire transfers, etc. Other types of fund transfers, such as via paper check, may also be employed. The player management servers, 200 and 202, may manage accounts for thousands or tens of thousands of players and may be capable of providing game play for thousands of player's simultaneously.

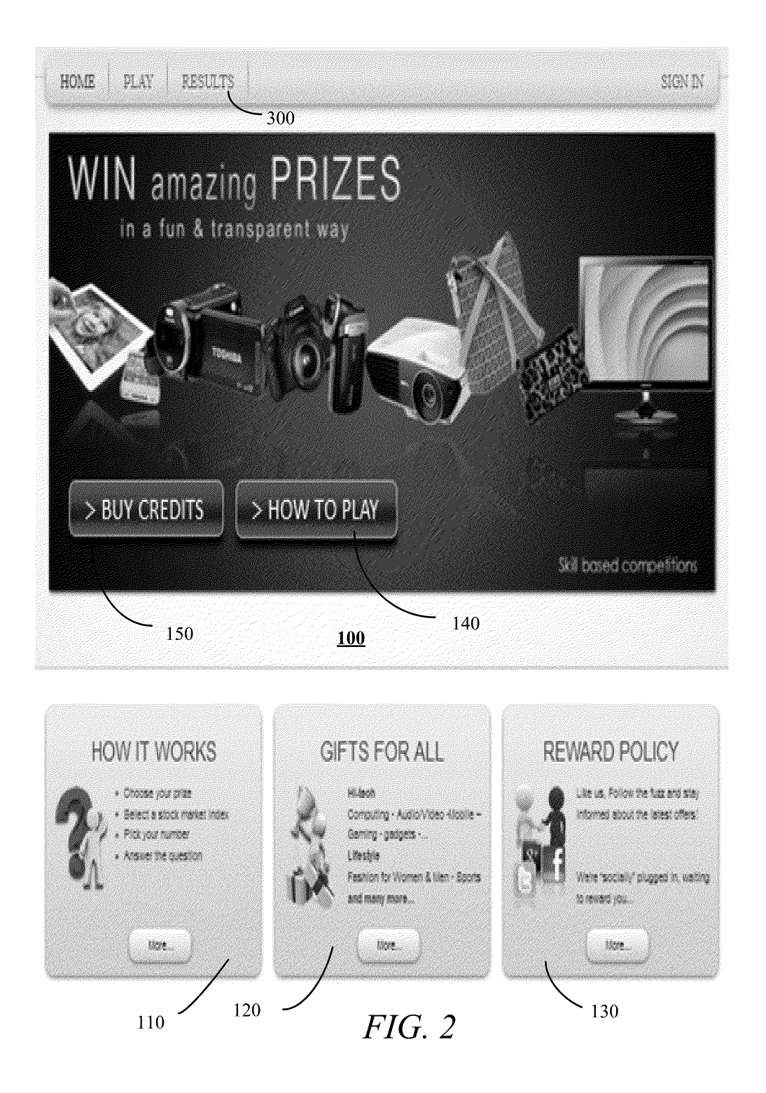

FIG. 2 shows an example HOME screen 100 of WINFUZZ.

WINFUZZ is accessible from any client device. In one scenario, the client device is a PC and includes a standard web browser, which when connected over the internet to game outcome server 201 permits the client device to interact with server 201.

An example user interface (UI) of HOME SCREEN 100 consists of three panels: (i) HOW IT WORKS panel 110; (ii) GIFTS FOR ALL panel 120; and (iii) REWARDS POLICY panel 130. HOW IT WORKS PANEL 110 is explained and described below. GIFTS FOR ALL and CUSTOMER REWARD POLICY panels 120, 130 explain policy and provide additional information of general knowledge of interest. For example, referring members may get points with which to play with, advertising credits, or discounts from any available shopping referrals originating from the site. Special bonus rewards for members may be made available through social networks integration.

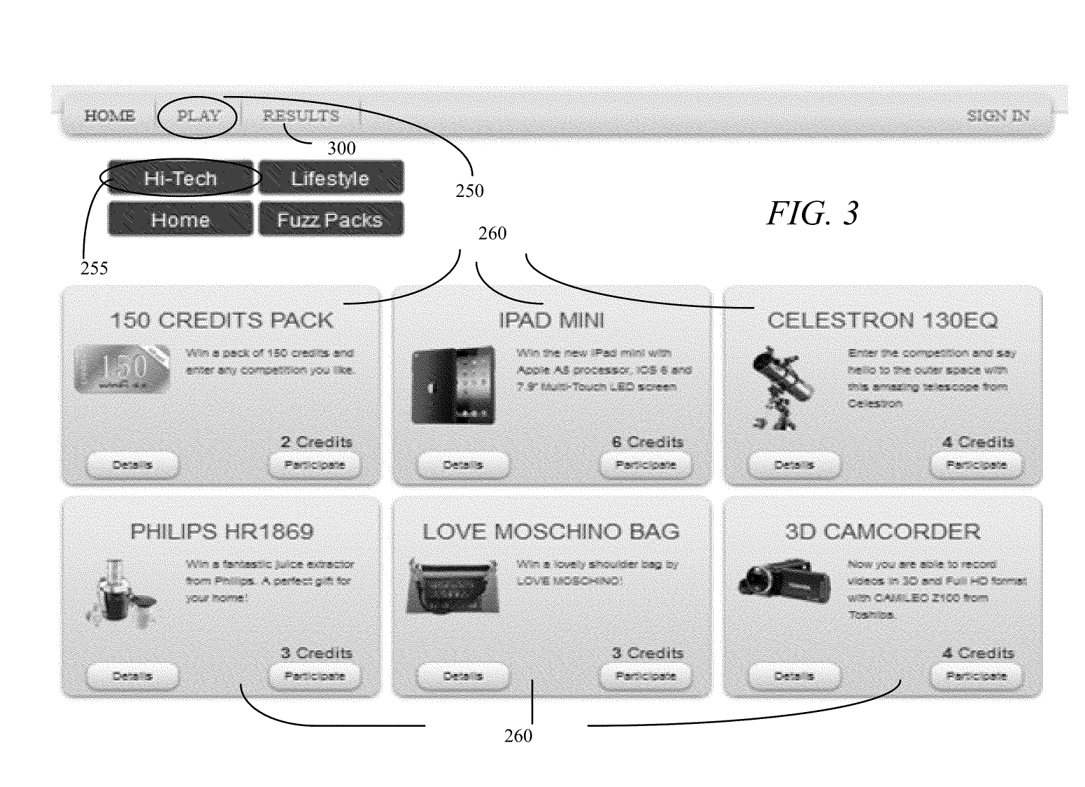

FIG. 3 is served up by server 201 in response to a visitor to the site clicking on the “store” tab 250. Here we see a list of items 260 which are available to be played for. Each item shown is a sub-item in category Hi-TECH 255. Each item has associated with it a details link describing the item in greater detail, and a participate link. The “participate” link takes the game player to the game as will be described further below. Above each participate link is a per credit cost, in points, when playing the game. As can be seen, the more expensive the item, the higher the per credit cost to play. Each player gains points by buying points. This is how the platform is able to generate revenue.

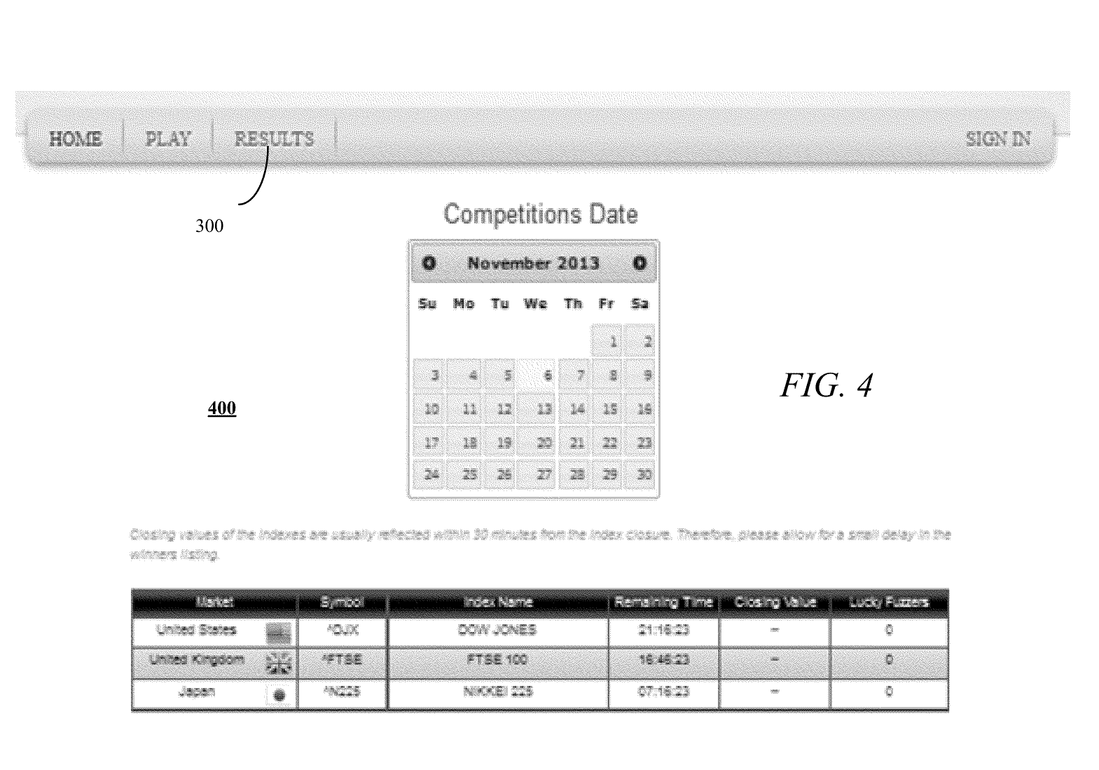

FIG. 4 is served up by server 201 in response to a visitor to the site clicking on results tab 300. Here, screen image 400 shows results of prior competitions displayed in historical fashion for easy access in accordance with an exemplary embodiment.

In order to be able to play, a member must confirm that it has read and understood a set of Terms and Conditions.

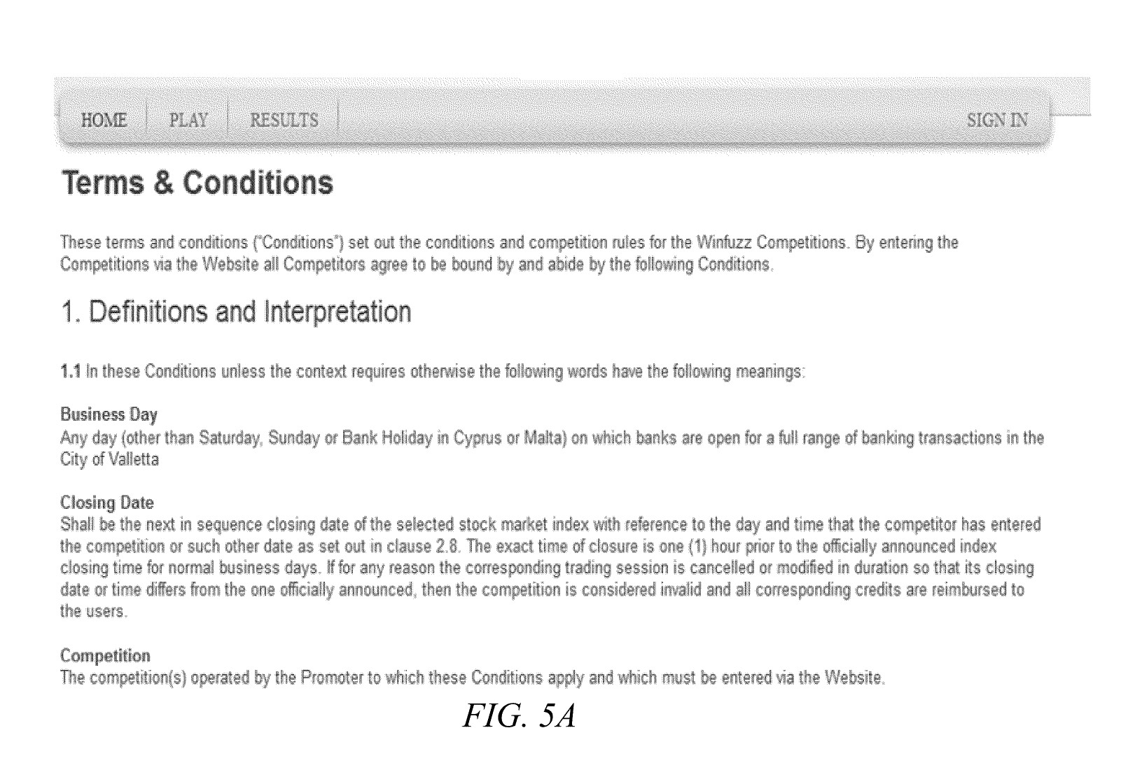

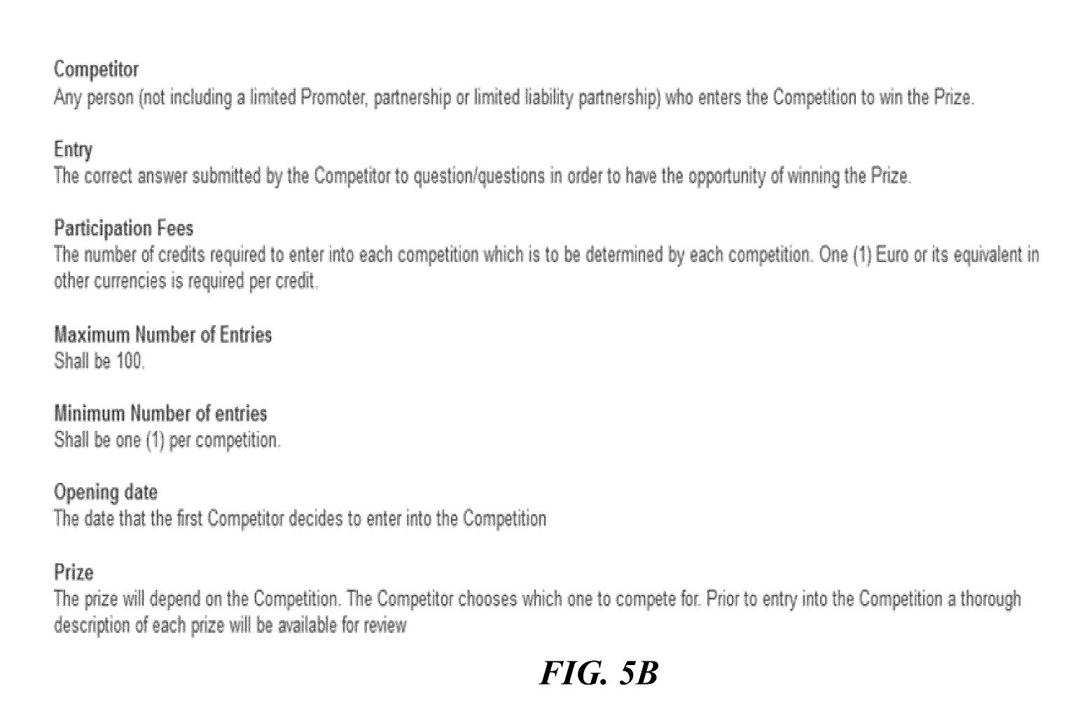

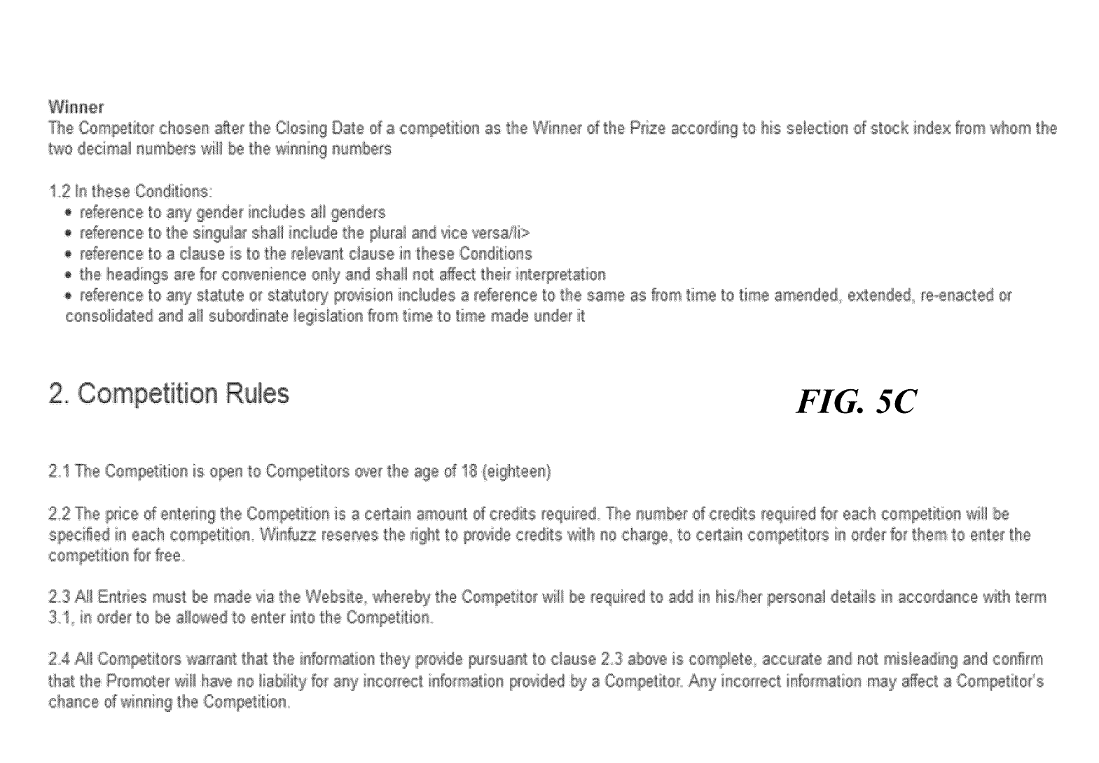

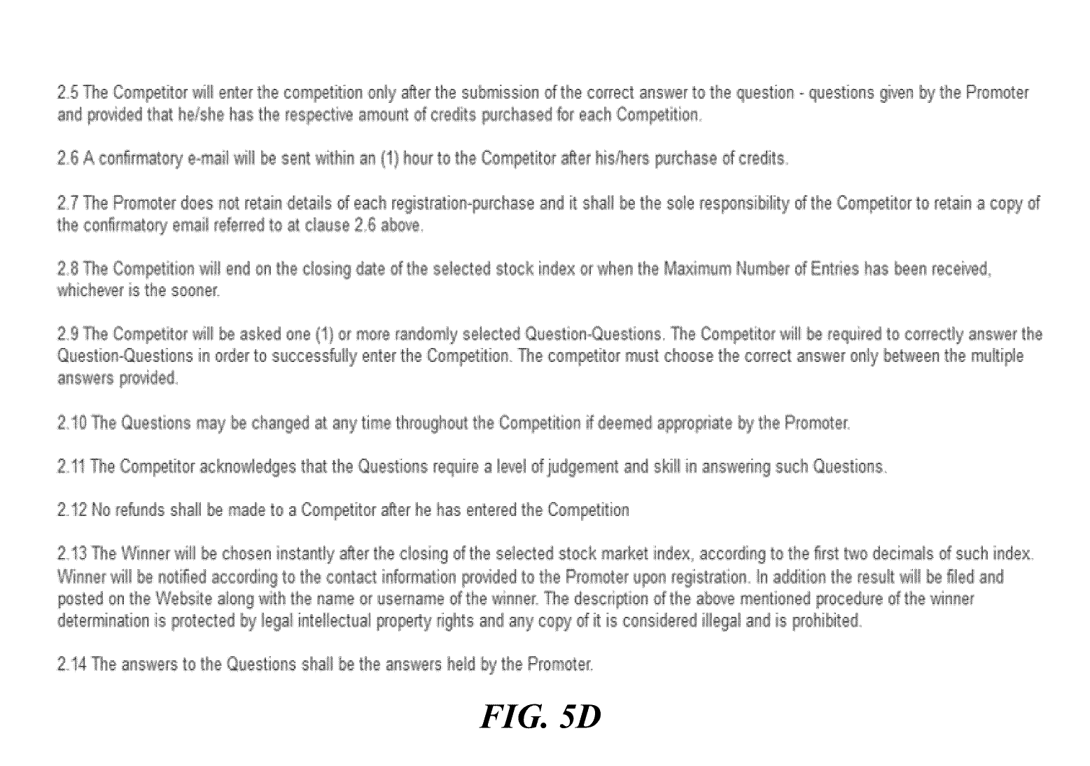

FIGS. 5A to 5D are a representative set of continuous page content showing a representative set of Terms and Conditions in accordance with an exemplary embodiment.

By clicking on an appropriate link on one or more pages, or at time of member registration, the visitor is served up the set of Terms and Conditions, which set out the legal and game play rules associated with the site.

By clicking on a different link “FAQ” (not shown), a visitor is able to view and one by one be presented with answers to a series of predetermined questions explaining the more commonly asked questions.

A series of example questions and answers follow:

What is WINFUZZ?

WINFUZZ is an online platform contacting gift-prize competitions. A level of skill is required in order to answer the question and enter the competition. Winners are determined in a transparent and indisputable way. No draw is contacted! We use publicly announced figures, the major Stock Market Indexes.

Why should I answer a question?

WINFUZZ operates as a skill competitions platform. This means that in order to participate you need to prove a level of skill by successfully answering a random question.

WINFUZZ questions have been carefully picked in order to cover all areas of knowledge and also provide various difficulty levels for the participants.

Who can participate in the competitions?

Currently, only EU residents can use our services. Users must be over 18 years old and have a valid European residence. After a winner is raised, he/she must send through e-mail a copy of passport or ID in order to identify the legitimate of age

How can I participate in the competitions?

In order to participate, you need to register with WINFUZZ and purchase one of the available credit packages. You will have to select a stock market index from the corresponding competition page. This will determine the time that the competition will end as well as the number that will raise the winner. One or more numbers between 00 and 99 should be selected. For each number a participation fee (in credits) is required. When you have decided on the numbers, a “skill level” question needs to be answered correctly. If the answer is right, you are eligible to participate.

How is the winner chosen?

Winners are determined in a 100% TRANSPARENT method. No draw is conducted. Winning number is the decimal part of the selected Stock Market index. As soon as the selected index takes its final value all participants know whether they won or not.

For example, a number of users have selected to participate on a competition based on the Dow Jones index.

If the closing value is 9864, 43, the participant that has picked number 43 is the winner of the competition. There is no way to manipulate the results!

How many times can someone participate in any of the competitions?

There is no limit. Each user can participate on each competition held for all products listed on the web site. A user may select as many numbers as he/she wishes. In case many numbers are chosen the participant will need to answer a question of higher level of skill.

Competition results are derived through the closing values of the corresponding stock market indexes. The closing value of the indexes is published through the internes by various well known sources: Bloomberg-Yahoo finance etc.

You can search for the closing value of the respective index and crosscheck whether you won or not.

The details of each index used in our competitions are:

DOW JONES Industrial Avg. (DJI)—USA

FTSE 100 Index—London Stock Exchange (FTSE 100)—UK

NIKKEI 225—(N225)—Japan

What happens if not all numbers in a competition are purchased?

It is not required that all 100 numbers are selected by the participants. The competition is considered valid even if only 1 participant has answered correctly on the given question, independently of the numbers picked in total.

What happens if a competition is cancelled while I have already participated?

A competition will be cancelled if the corresponding stock market has closed prior to the officially announced time. In that case credits will be refunded to your account.

Can I withdraw my participation?

No, it is not possible for someone to cancel the participation and get refunded.

How am I going to receive the prize I won?

Prizes are gifts and are delivered to the winners completely out of any charges. As soon as a winner is raised, WINFUZZ will send the gift on the winner's delivery address. The winner will be notified and a delivery tracking number will be sent as well.

What is your return policy?

Products may be returned only if found defective upon delivery, if a claim is made within 7 days from the time the item is received.

Can I have my money refunded and if yes under which conditions?

Our policy is that money cannot be refunded! Please communicate with us if you have a special reason for such a request.

Can I exchange my credits with the respective amount of money?

It is not possible for someone to exchange credits with money.

What are the payment methods for credits purchase?

You can use PayPal or your Visa, Visa Debit, Mastercard as well as other internationaly accepted payment solutions.

### How it Works Panel Information 110

In accordance with an exemplary embodiment, WINFUZZ is a platform running online competitions that are skill based. In addition to any general terms and conditions that may be available, a pop-up up menu, selection screen, and/or help icon may be activated to explain game rules. For example, in order to participate, a player may for example be required to give the correct answer on a random question (multiple choice). The players take part in a unique, innovative and transparent mechanism from which is determined a winner of the competition.

In a preferred exemplary embodiment, each player, prior to answering the question, must select one from a predefined selectable set of Stock Market indexes. Each index comprises a different competition for the selected prize.

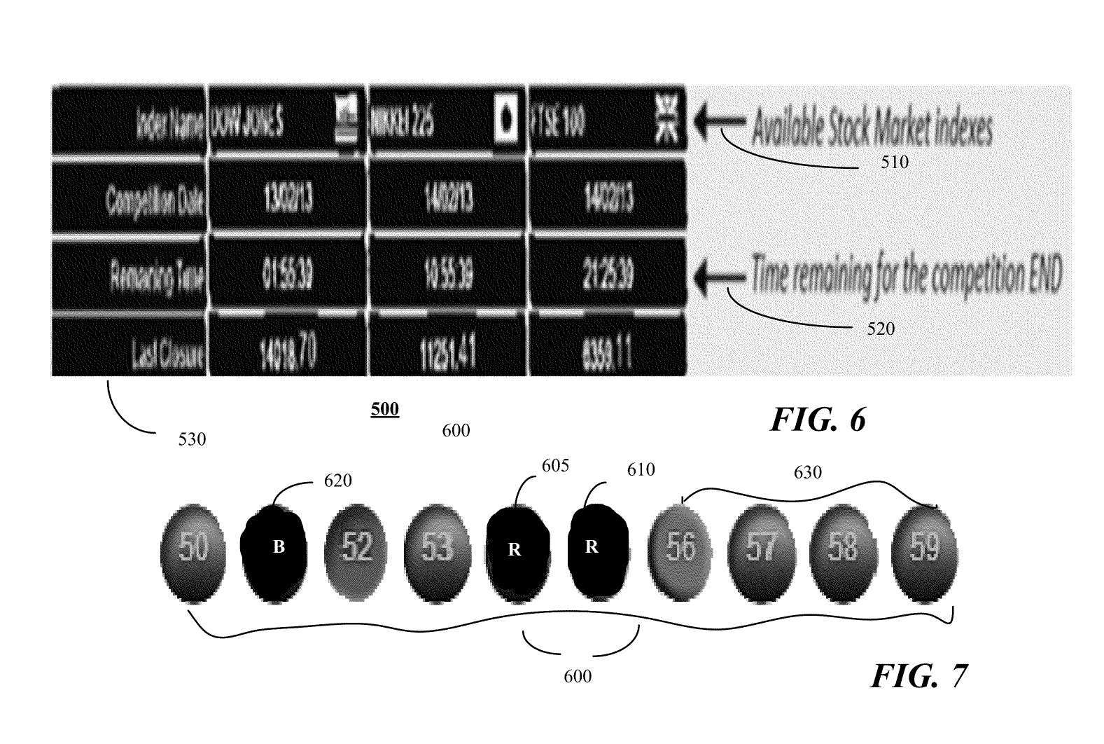

FIG. 6 shows a table of indexes to be used as player choice's of algorithm to be used for random number generation of winning number.

The top row 510 identifies available stock market indexes for each represented column Row 520 shows how much time is left before a current competition session is due to expire. Column 530 is segmented into (i) Index Name, (ii) Competition Date (iii) Remaining Time, and (iv) Last Closure. A player selects an index he/she wishes to define as the index from which winning results are to be derived. Since winning numbers are derived from an index, the competition date is the date on which the stock market for the selected stock market index closes.

An Index I selected by, for example, hovering over any one index and clicking on it with a mouse. A currently identified index selection may be displayed in a different color scheme to help the player to easily identify which column and row he/she is over while hovering across table 500.

In accordance with an exemplary embodiment, once an index is selected, a set of numbers from 00 to 99 will be displayed on the screen, as described below in greater detail. These numbers correspond to the decimal part of the closing value of the selected Stock Market index and will be used in order to determine the winner of the competition. The player will be asked to pick one or more numbers. The more numbers chosen this will increase the level of skill required to answer the question.

FIG. 7 is a representative single line of numbers (50 through 59) from the list comprised of numbers 0 through 99.

Circles 605, 610 are labeled R and correspond to numbers 54, 55, respectively. These circles/numbers will also appear in red, all will appear only in red, to indicate that they are already reserved by other participants and are not available for the player to select in this round of the competition.

Any circle/number labeled B (such as circle 620) will be colored in blue to indicate those numbers that are currently selected (by one or more players) but not yet submitted. When a player submits the numbers and successfully answers the question, the blue numbers will change to red. Again, the actual labels B and R may not appear and are used mostly for clarity in explanation.

Numbers that are not labeled (such as circles 630), except maybe other than to show the corresponding number itself, will include neither a “B” nor an “R”, nor any kind of specific color designations (such as blue or red).

In each case, for each number selected a participation fee is required (which may be in the form of credits or cash).

As soon as a player submits his or her numbers, a question is presented. In order to participate in the competition, the player must give a correct answer.

Questions have been carefully picked in order to cover all areas of knowledge and also provide various difficulty levels for the participants. By selecting more numbers, a higher level of skill is required.

If a wrong answer is given, the participation fee (credits) may not be deducted from a player account. This fee will be applied only to those who have successfully answered the question.

A competition comes to a finish when the selected Stock Market closes.

The above describe play scenario provides a unique and fully transparent mechanism to determine a winner. By looking at the decimal part of an index closing value, and comparing ones selected numbers to this decimal, a random form of number selection generation is provided, but the result, is one that is easily verifiable by the player, and thus more likely to trust the game results. Once a winner is identified, the server 201 is set up to identify who the winner is and to engage him or her, via the web-browser UI, for example, to coordinate shipping and other formalities of the winning prize.

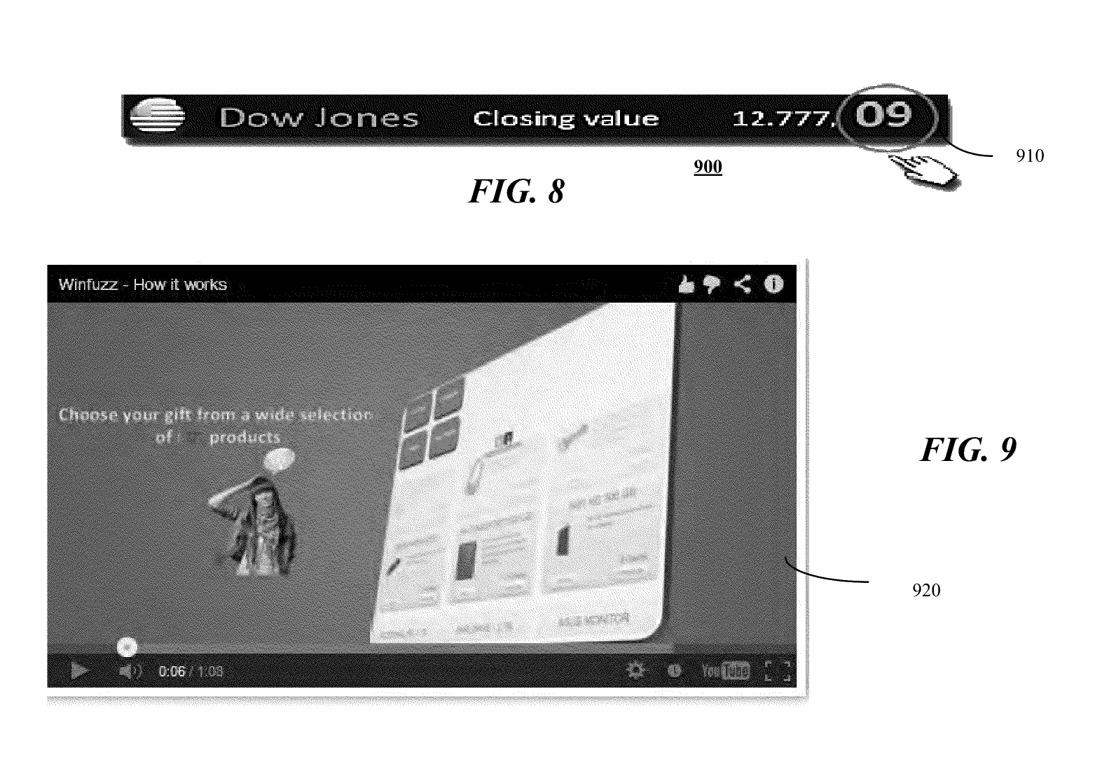

FIG. 8 is a close up result of an index 900, with the index decimal part 910 shown blown up so the player may easily distinguish this portion from the rest of the non-decimal part of the number, which will typically not play a role in the winning number selection.

One skilled in the art would appreciate that it would be an obvious design choice to base a winning number on any two combinations of digits. The unique aspect is the fact that a stock market index is a reliable index from which to generate winning numbers and combine those with a KENO type game.

By having multiple indexes to choose from, multiple numbers can be selected from and different indexes used to arrive at winning combinations. In a related scenario, the game interface is a KENO like interface, such as a wheel with a 100 numbers, similar to KENO, or a wheel with less than 100 numbers as in the case with ROULETTE.

Referring back to FIG. 2, a link 140 to an easy to understand VIDEO is provided. By clicking on the link, the visitor is presented with a video.

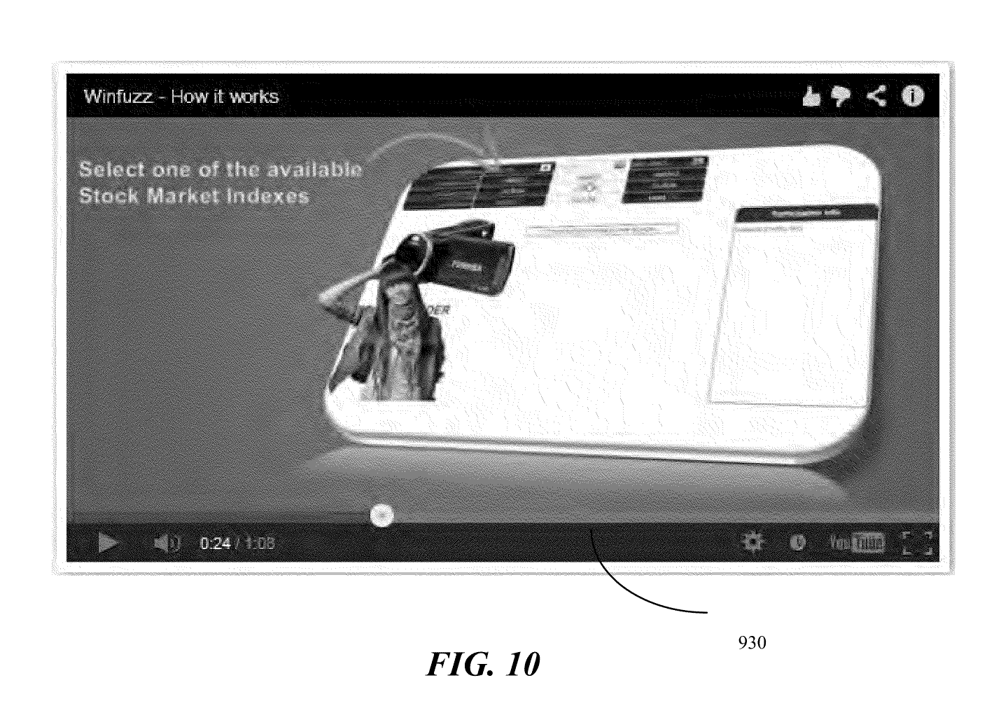

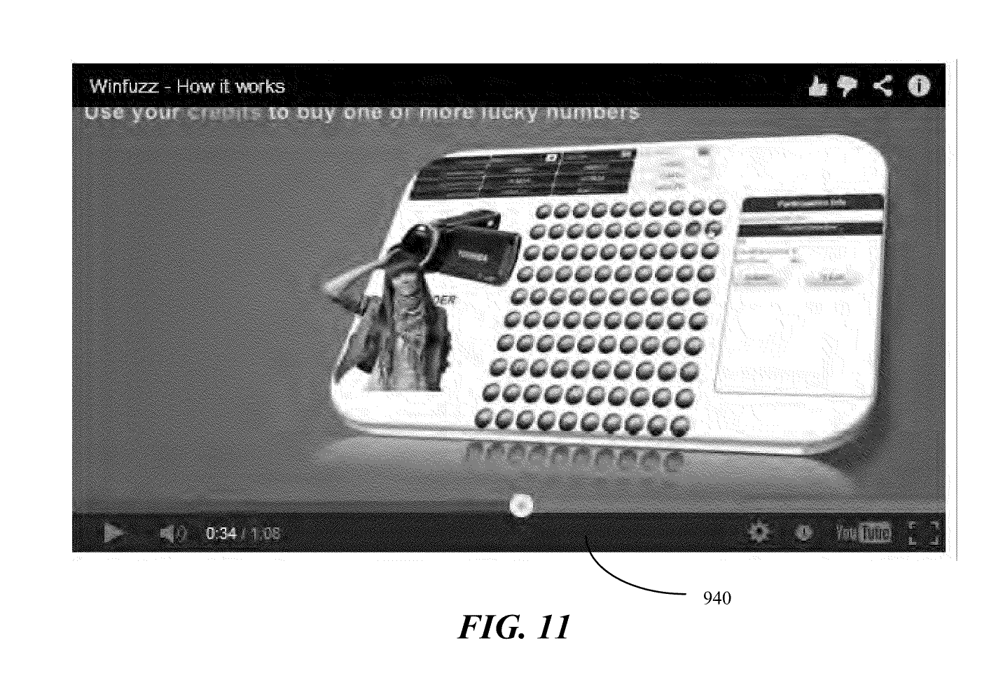

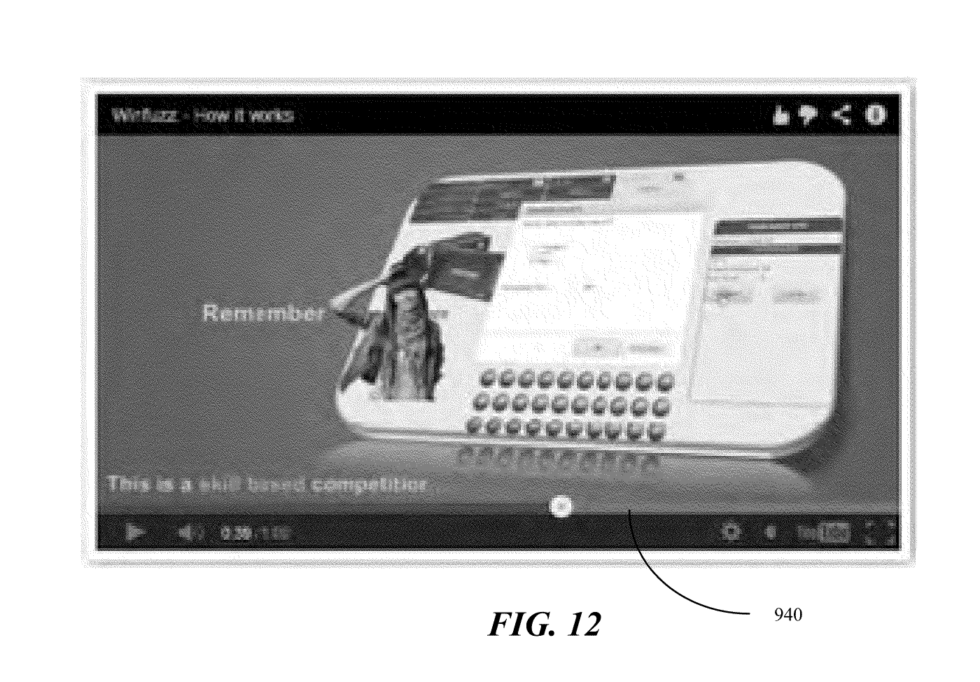

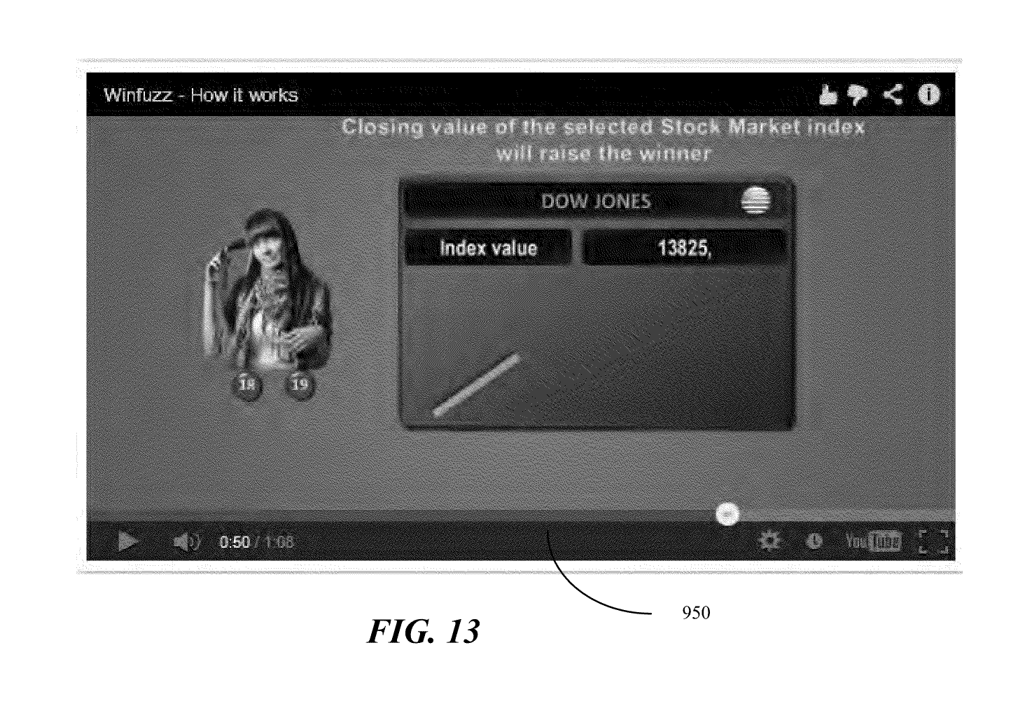

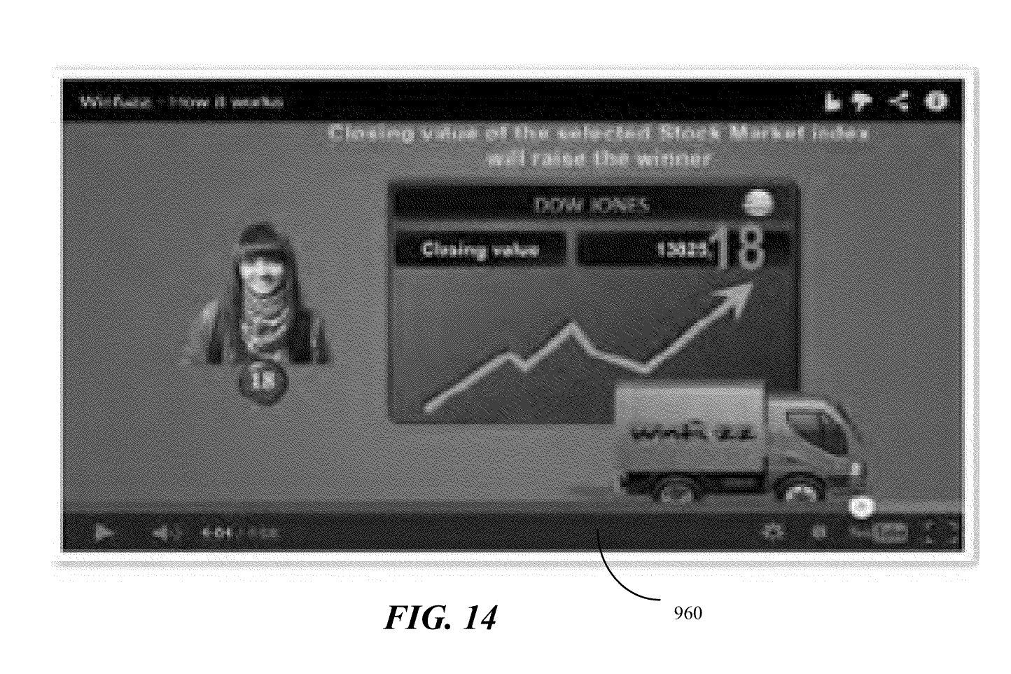

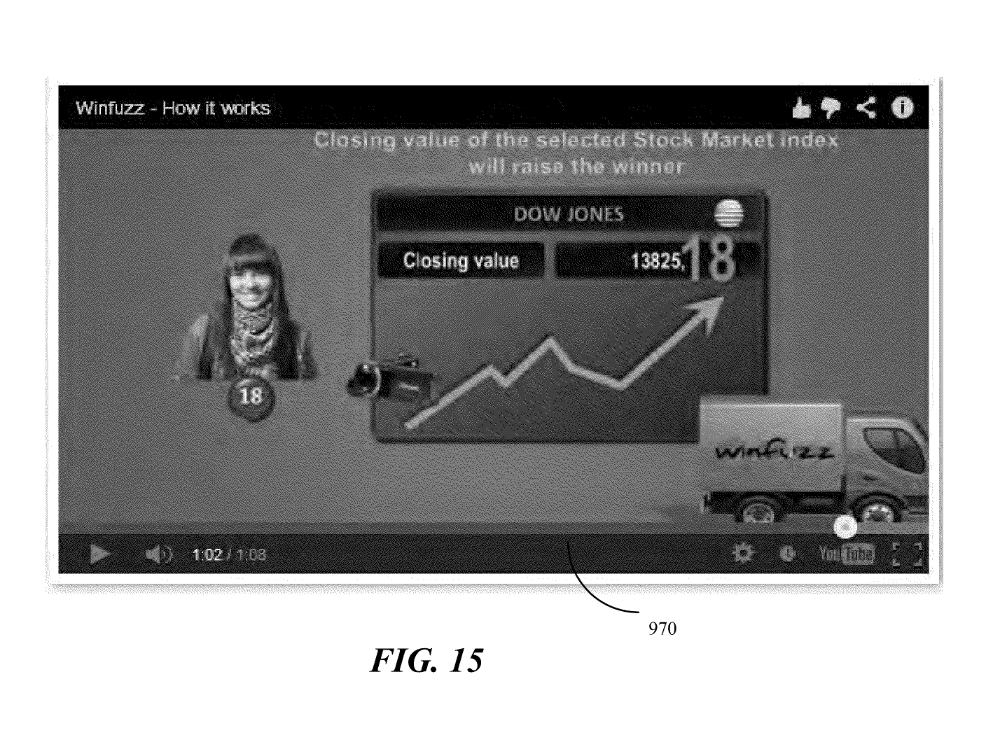

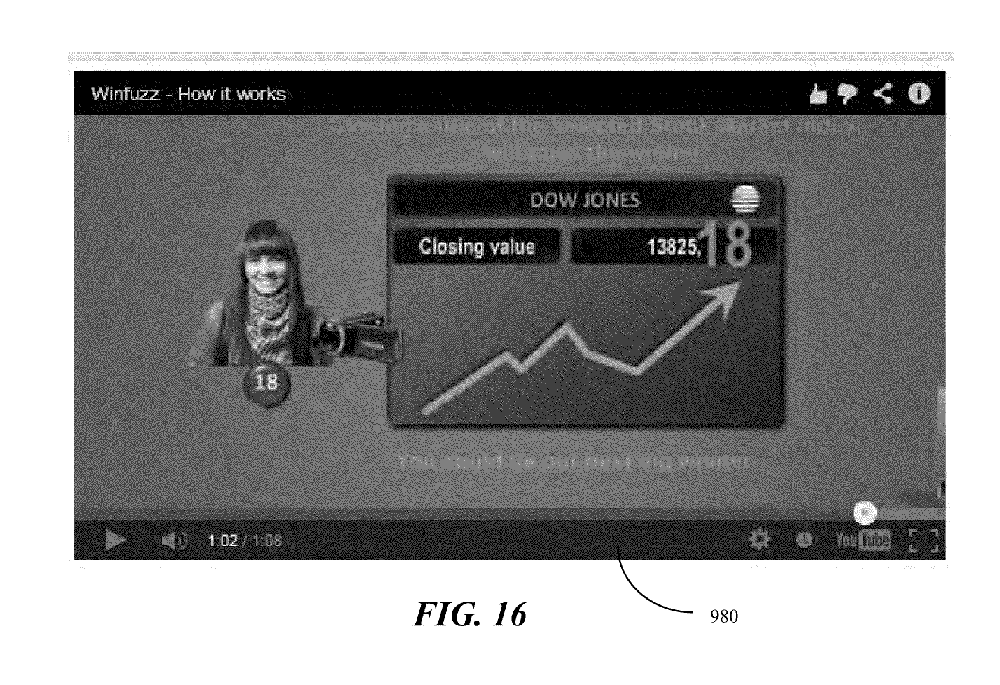

FIGS. 9 to 16 show a representative set of slides (920-980) from the video which help customers visually understand game rules.

The stock market index thus serves as a random number generator (RNG) selector in this application. A stick index is selected as it is both easy to automatically obtain by server 201, it is a reliable and highly trusted value, and it can be easily confirmed by game players with access to virtually any one of thousands of sites dedicated to news and finance. The selection of a stock index automatically determines when any one game associated with the selected index comes to a close and the time of day when a win (or lose) outcome becomes determinative.

It should be appreciated that the game is a game of chance and the odds of willing and losing are a factor of how many numbers are selected, as well as the number of numbers available to be selected.

Number selection may be open (available) as to all numbers or closed (unavailable) as to some numbers. (Colors are used to indicate whether one or more numbers are available for example, as previously described).

Numbers may be unavailable for different reasons. Let's take as an example that the prize is a $30,000 new car. And let us assume that the number of credits needed for the right to select one of the 100 available numbers is 500 credits. If we further assume a cost per credit to acquire is $1.00, a player would need $500 just to be able to bid for one out of 100 numbers. To bid for all 100 number might guarantee a win, however, the cost to acquire all 100 numbers, at 500 credits per number, is 500×100 or 50,000 credits. The cost to acquire these credits is $50,000. As a practical matter, this in itself acts as a deterrent. However, let's assume that two and only two players bid for the car in a given round of game play. And let's next assume that both of them burn 500 credits to pick the number 53, and by luck, the closing price of the relevant stock index is 11,823.53. This would make both winners and entitled to the same prize. This is bad for the platform as it only intended to give away one car.

One solution is to limit the number of prizes in all or certain high value products to one win per round of play. One way to do this is to for server 201 to make numbers selected by one player unavailable as to other players. In one scenario, numbers become unavailable once the number of times that number is selected in a given round, exceeds a desired number of products available, or a predetermined number of prizes that the site promoters has determined are eligible to be awarded.

In an alternate approach, numbers selected by one player are reserved and unavailable as to later players in the same round, but only for high-net worth products.

High net worth products may be subject to yet a second determinative. For example, in addition to selecting a stock option exchange which will determine the winning number at the close of market, players could be required to select a second exchange and a number associated with that exchange, as earlier described. When two winning players qualify for the car, in the example above, the winner is determined based on the person whose qualifying second number, matches or comes closest to the actual number of the second stock exchange close, without going over.

Now, going back to the questions, when a player submits numbers and successfully answer the question posed, those numbers will turn red. For each number a participation fee is required (in credits).

As soon as numbers are selected, the question is presented, in the form of a pop-up. In order to participate in the competition player must give a right answer. Questions are selected in advance and selected to cover a range of different topics, and with varying degrees of difficulty.

The more numbers selected for a given round of play, the higher level of skill that will be required to be able to qualify to play.

Wrong answers may or may not result in a credit loss. If a no credit-loss policy is in force, fees/credits are lost only when questions are successfully answered since at this point in time, the player has committed him to the round of play.

Again, the competition ends when the selected Stock Market closes and the stick market closing index value is electronically published and available.

Prize Selection

Players are given the option to select from a variety of product offerings to try and win. Players are presented with a product selection menu and permitted to navigate through a market place of products.

It is contemplated that some of the available products may be available to purchase direct from the same market place, in which case a purchase price may also be provided.

In another scenario, the products are merely links to affiliate products sold by third parties. The site itself, in this case WINFUZZ, does not actually get involved with buying, selling, delivering, returns, or any of the functions associated with traditional online retailing. Instead, the products are third party products. These products could be offerings from a traditional online retailer or from an ecommerce site such as AMAZON, EBAY, GOOGLE AFFILIATE NETWORK, or the like.

In yet a further embodiment, the site includes a product grabber feature such as that disclosed in U.S. Pat. No. 7,606,740. The product grabber feature would make it possible for the webmaster to a site like WINFUZZ to be able to retrieve and promote affiliate products from the web very easily and quickly. This way, product offering can be selected based on geographically relevant products of interest to a player, based on his current IP address, profile, or other information. Alternatively, product offerings can be served based on most popular seasonal items of interest, such as gift sets and electronic gift gadgets during holidays, Mother's Day relevant selections and the like.

Toward that end, the present solution combines online retailing practices and gaming in a new way.

In a related scenario, third party items are made available to bid on by the third party retailers themselves. The retailer sets the credits he is willing to accept as a wager, and undertakes the full commitment to the winning party to process, package, invoice, and deliver the winning product. The platform in this case acts only as an intermediary between player/buyer and seller. A commission may be charged for providing this service by the platform, it may share in the risk with the retailer, it may enter into a risk-reward sharing arrangement, or any other like arrangement suitable to both sides.

In yet a further exemplary embodiment, the third party items are items that are donated with the intent of any money raised to be used for charitable or philanthropic purposes. The platform simply charges a commission in acting as facilitator of the buyer/seller transaction.

The platform is unique in that it brings together in a clever way two unique segments of the marketplace. On the one side, you have individuals that enjoy the thrill of wagering to acquire something of value for less than it may be worth; and on the other, retailers who enjoy the thrill of making money, but who are always on the look-out for opportunities to minimize the overstock risk and willing take any reasonable price to be able to properly manage one's business inventory.

In yet a further scenario, the gaming platform is set up as an affiliate network whereby advertisers are allowed to join and promote their products. In one scenario, the advertisers select how many points they are willing to offer for the opportunity to benefit from gaming profits.

The player simply need identify which product it desires and hopes to win while wagering by going to a list of merchants. The player can do this either by using conventional tools such as those provided by LINKSHARE, GOGGLE AFFILIATE NETWORK and other affiliate operators all of which operate to serve the most relevant results during product code searching.

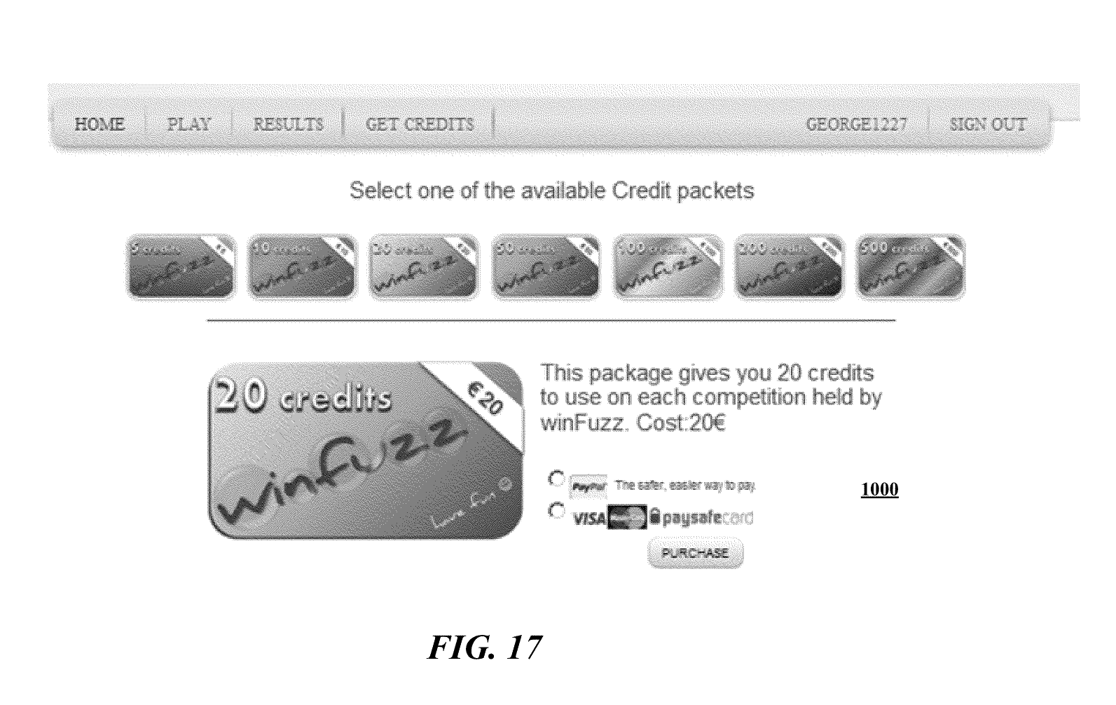

FIG. 17 is an example user interface (UI) screen 1000 showing the process of adding points. This screen may be accessible from, for example, clicking on the “BUY CREDITS” button 150 shown on the HOME page 100 in FIG. 2.

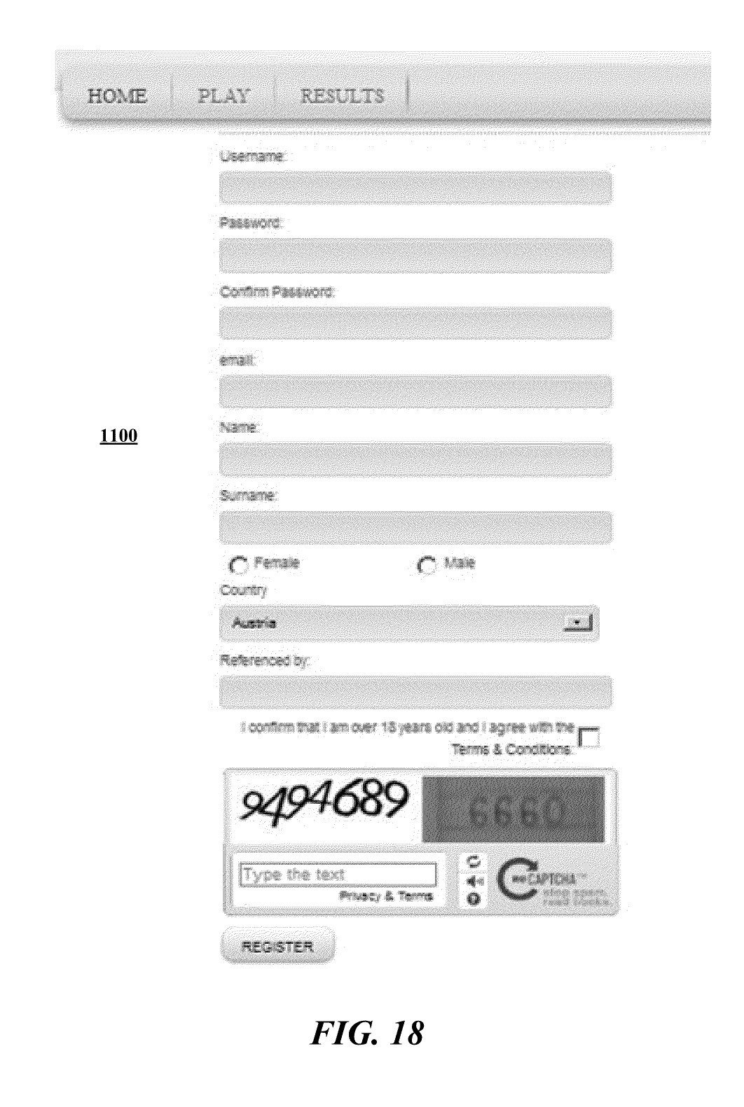

FIG. 18 is an example UI screen 1100 for the registration of new members. Only registered members qualify to play and buy points.

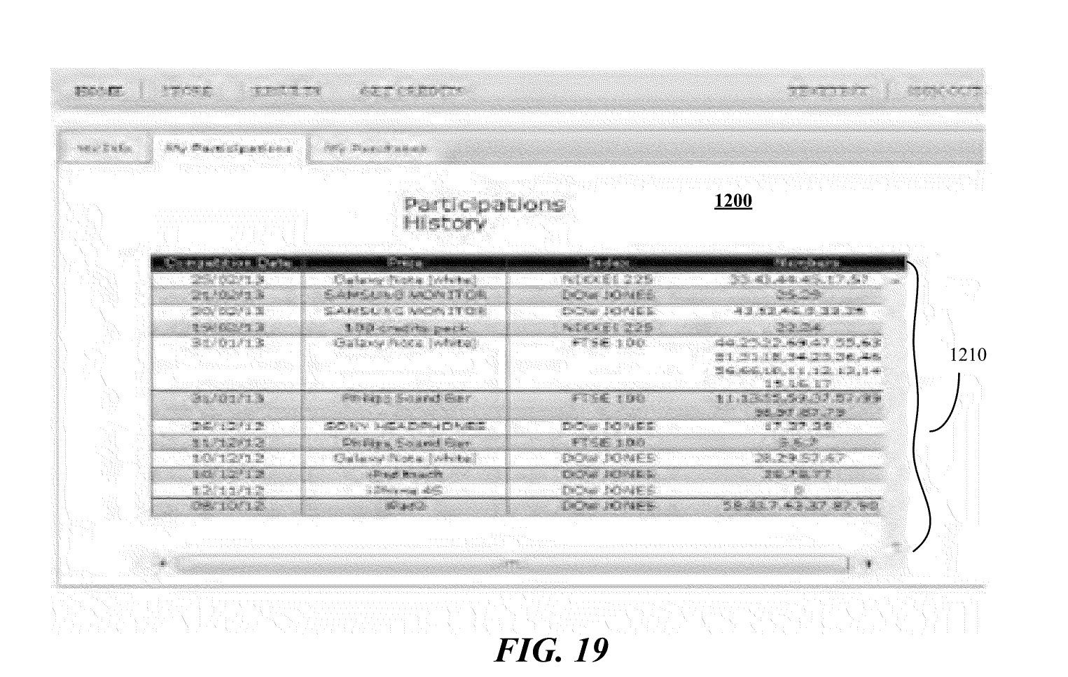

FIG. 19 is an example UI screen 1200 of a registered game player's gaming activity (in table form 1210) for a given period of play.

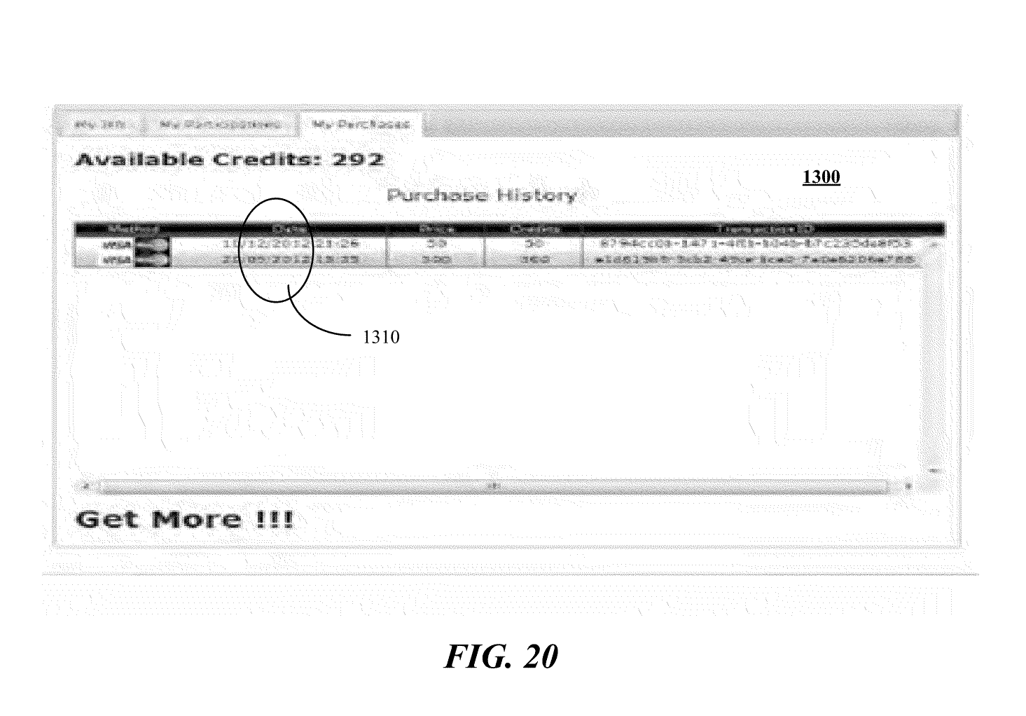

FIG. 20 is an example UI screen 1300 of a registered game player's purchase activity shown in table form 1310.

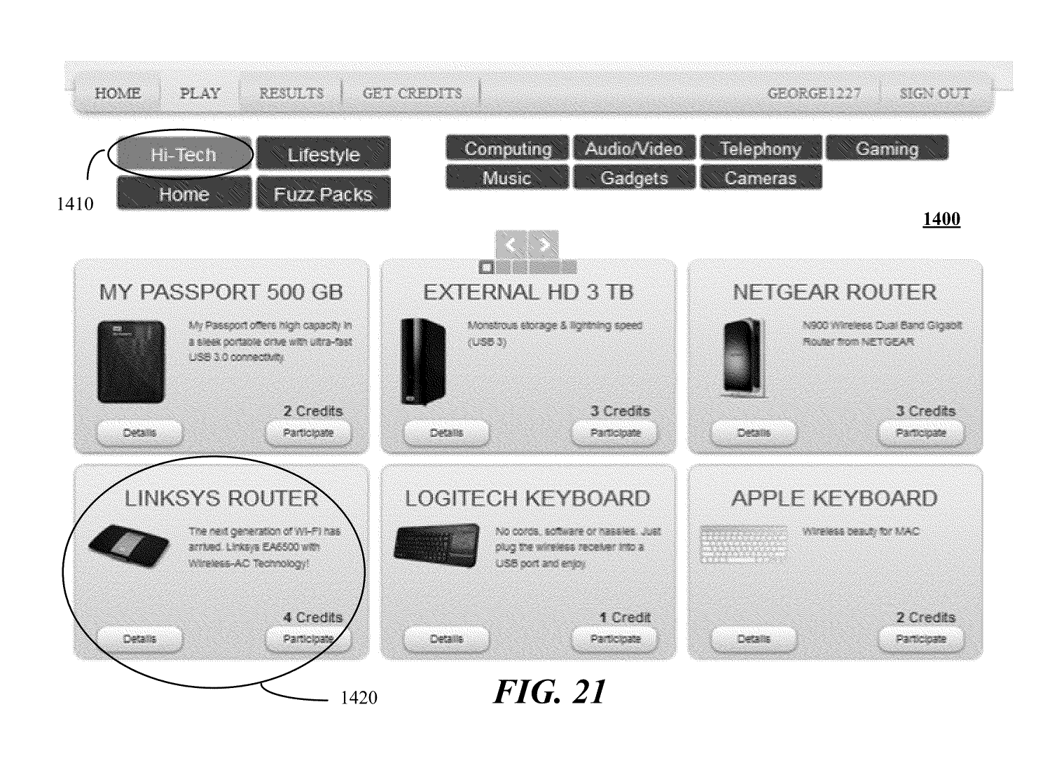

FIG. 21 is an example UI screen 1400 showing six new products available for wagering when player selects and clicks on the Hi-Tech tab 1410. The game player has hovered over and is about to select the LINKSYS ROUTER product 1420 to play for.

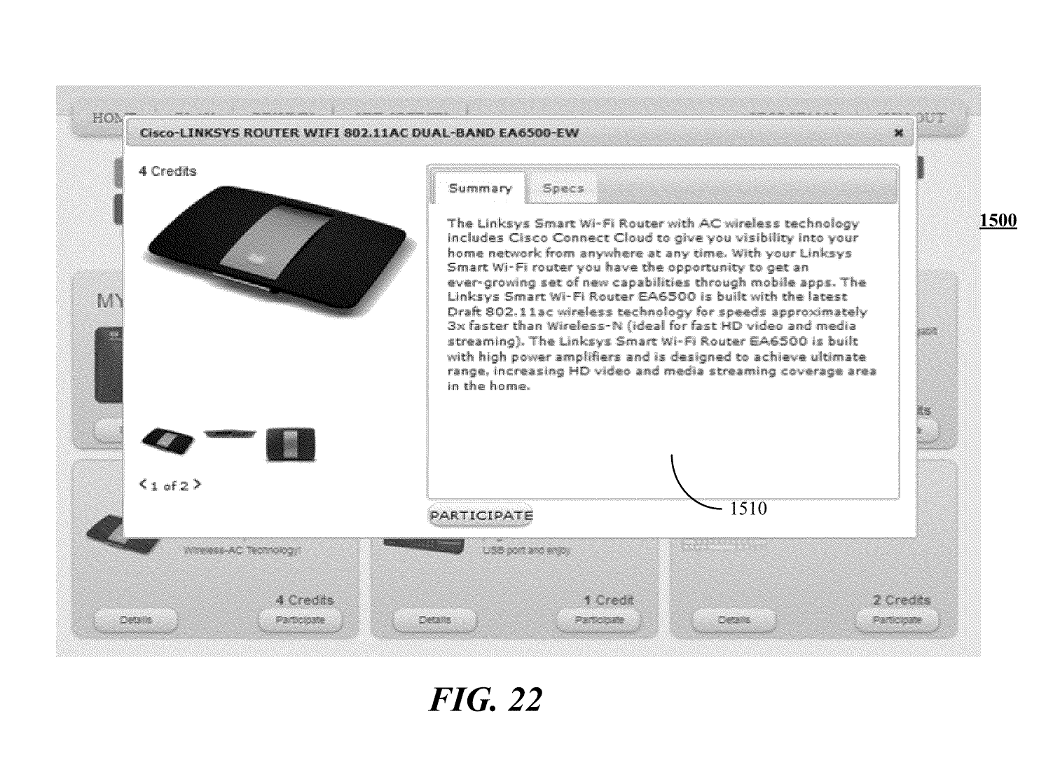

FIG. 22 is an example UI screen 1500 showing a pop-up 1510 automatically generated to show more details for the selected product in FIG. 22.

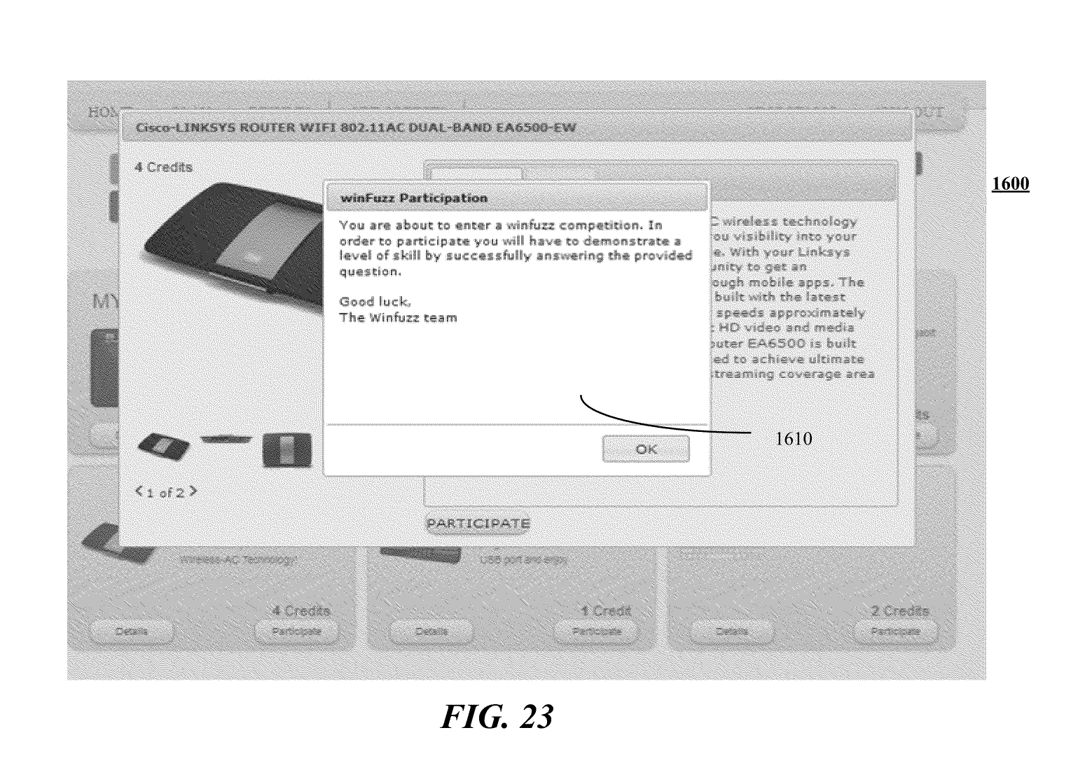

FIG. 23 is an example UI screen 1600 showing a pop up 1610 generated in response to the player having clicked on the “participate” icon and is invited, by way of a new pop-up, to confirm that he will be required to correctly answer a question as a precondition to being able to wager on the item.

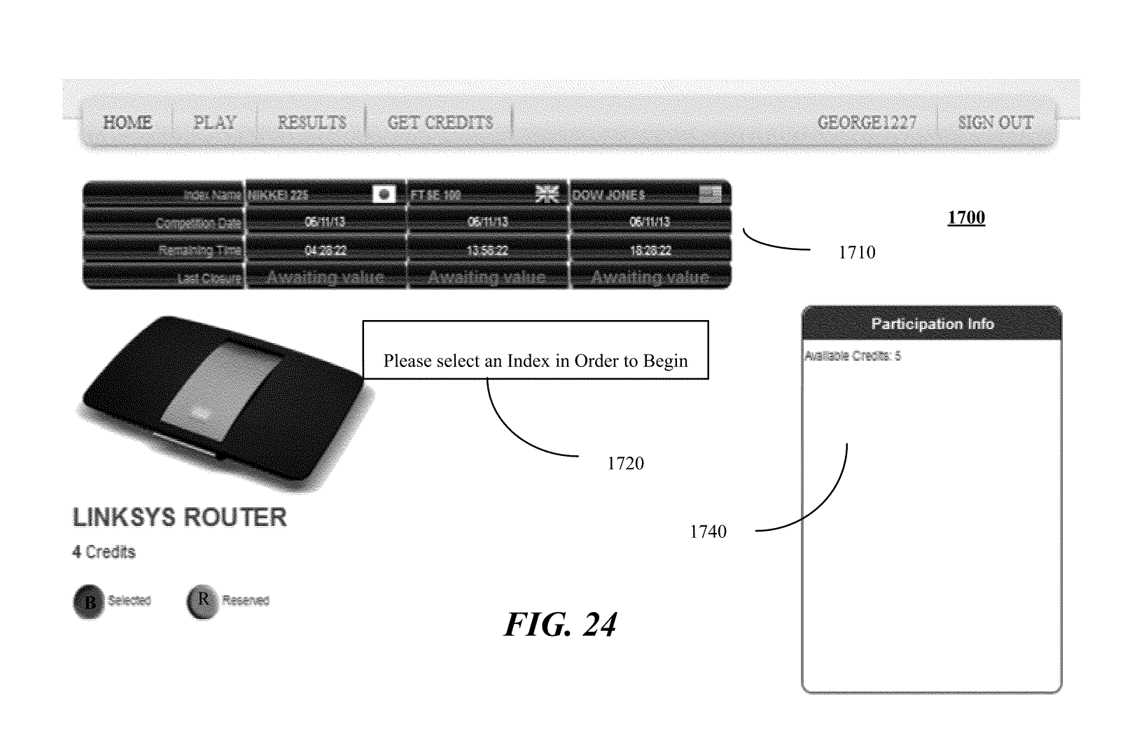

FIG. 24 is an example UI screen 1700 showing that a player, before answering any question, is next taken to a new UI where he is instructed (1720) to select an index from index table 1710 to be used as the random number generation variable that will determine if a selected number will ultimately have won or lost. Participation info table 1740 keeps a record of points available for play.

As explained above, while not shown, the player may be asked to select a second stock exchange and number, either to break a tie in event of more than one winner is announced, or simply to be eligible to qualify for a second prize, bonus, or jackpot. In yet another scenario, the adding of yet another variable (whether it be a second stock index and value, the price of Coca stock on close, the weather in India at 2:00 PM the next day, or any other random number or determinative, is provided as a form of insurance. In this regard, in event of loss, should the second opportunity prove successful, player may be given another free round to play again, partial credit, a full refund, a combination of the above, or any like alternative.

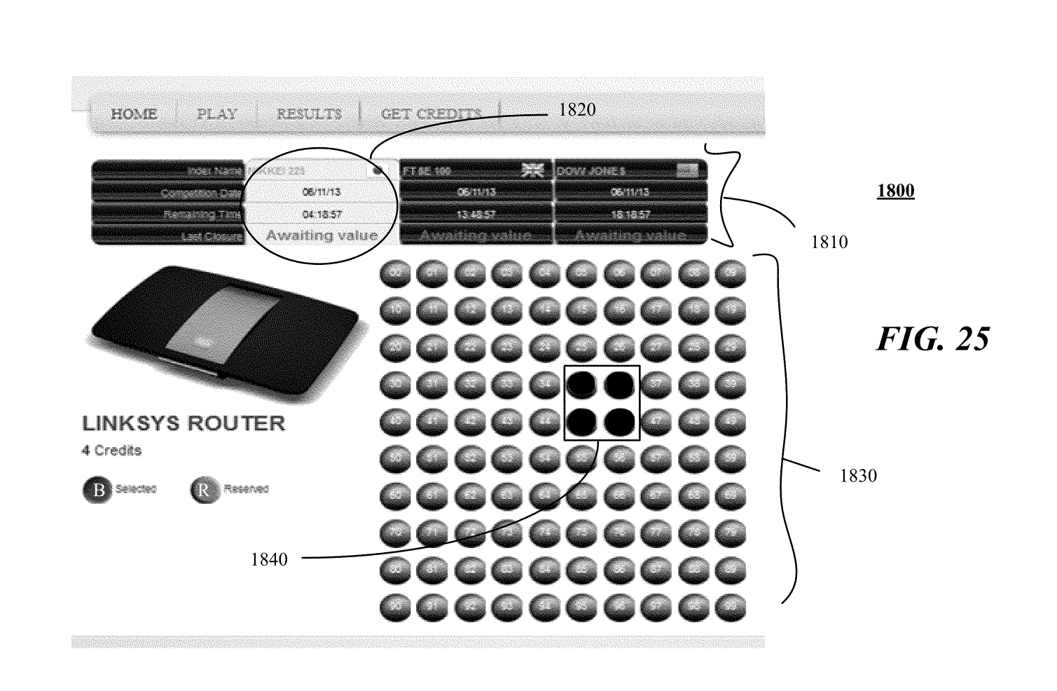

FIG. 25 is a UI screen 1800 showing player selections. Here, the player selected the NIKKEI 225 Index (1820) as the Index of choice from the displayed index table 1810 from which the ending decimals will determine the winning number. He has also selected numbers 35, 36, 45, and 46 (shown blacked out within box 1840 from the set of numbers in numbers table 1830). The total cost is 12 credits=4 numbers×3 credits each). Upon selection, those numbers become automatically reserved for this player for this competition. In an alternate scenario, each number is reserved only after a question is answered correctly as will be seen below, or not at all, or reserved after a maximum number of multiple, same competition players, have selected the number for the current game.

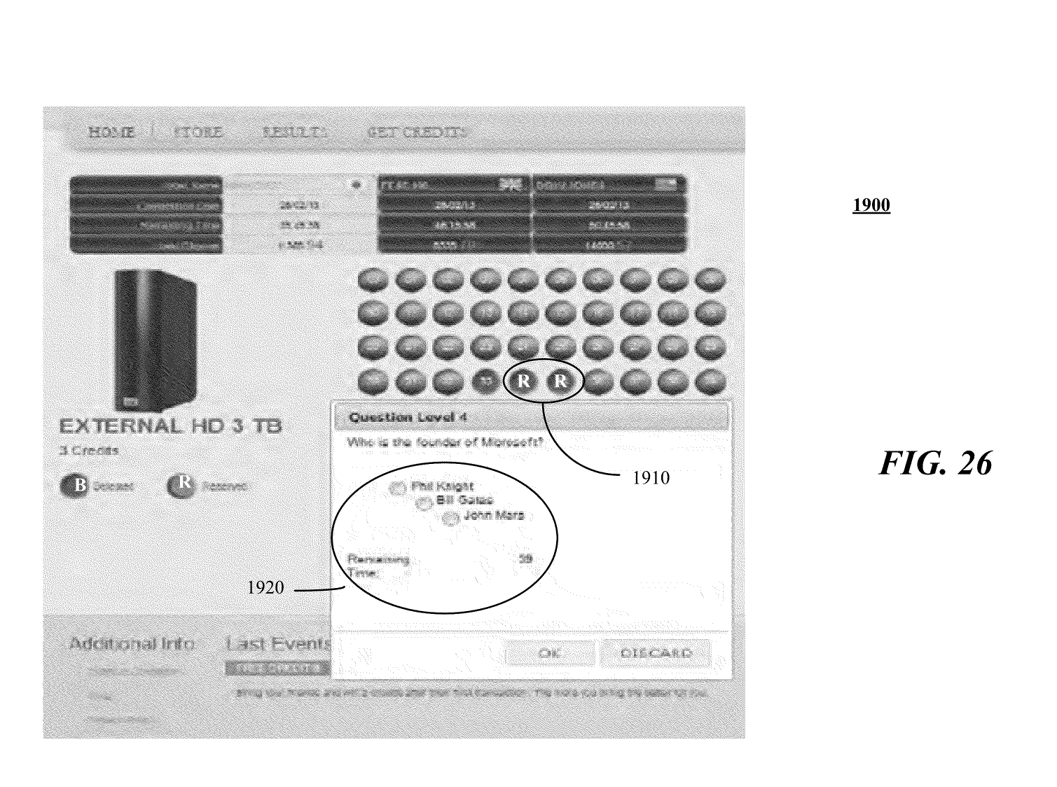

FIG. 26 is a UI screen 1900 of a pop up 1910 that is generated by the server 201 in response to a different (second) player wanting to buy a different product (EXTERNAL HD 3TB). As with the last player, this player was required to walk through a variety of menus, select an index, and a set of numbers just as with the first player. For argument sake, let us assume the second player wants a different set of numbers: 34, 35, 44, and 45. The numbers are reserved and the second player is taken to a first question he/she must answer correctly.

Pop-up 1910 shows the question presented to the second player in our example. The first player may have been presented with the same or different question (not shown). This is not relevant since each competition is independent. (In an alternate embodiment, the competitions can be made more interactive to increase cross-game activity, and provide an opportunity for additional wagering flexibility and winning options.)

As previously explained, the questions are selected dynamically based on a number of predetermined factors, such as value of product wagered for, odds of winning based on number of KENO-like number selections made, and the like. In the illustrated example, the second player is asked to identify from a multiple-choice option, who for example is the founder of Microsoft, assuming the right answer is given (i.e., Bill Gates), then the correct player selection will be shown as having been made by the second player.

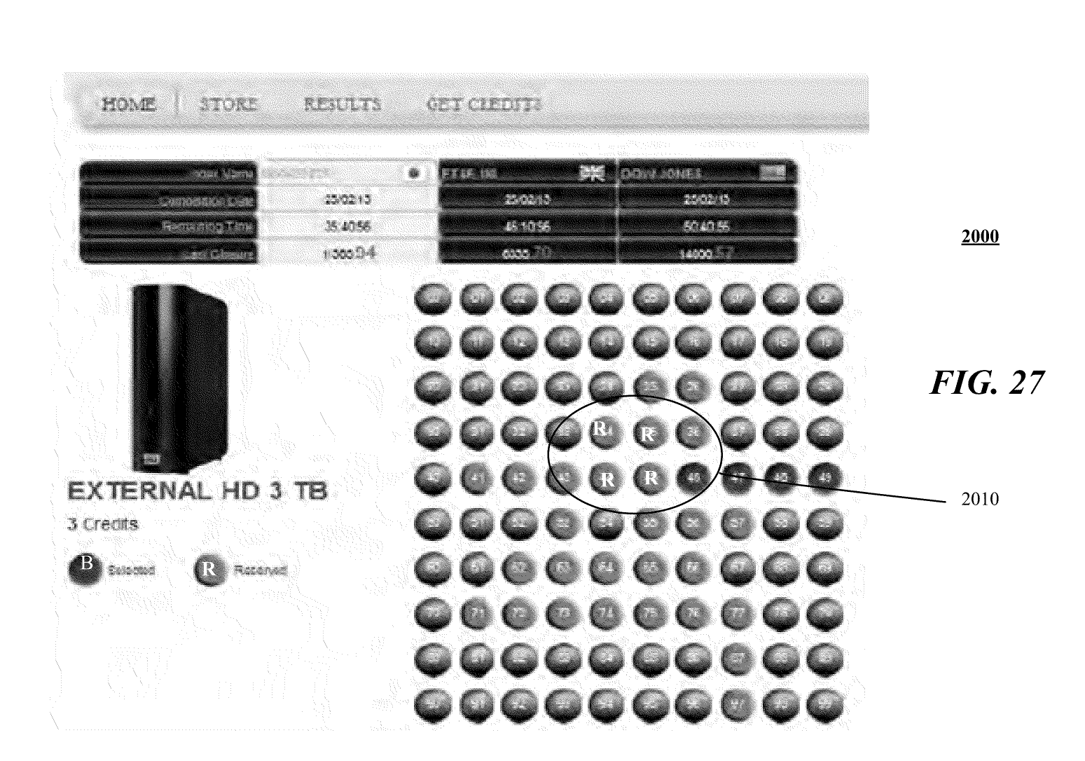

FIG. 27 is a UI screen 2000 of a further pop up 2010 confirming the correct answer and locking in the numbers previously selected by the second player.

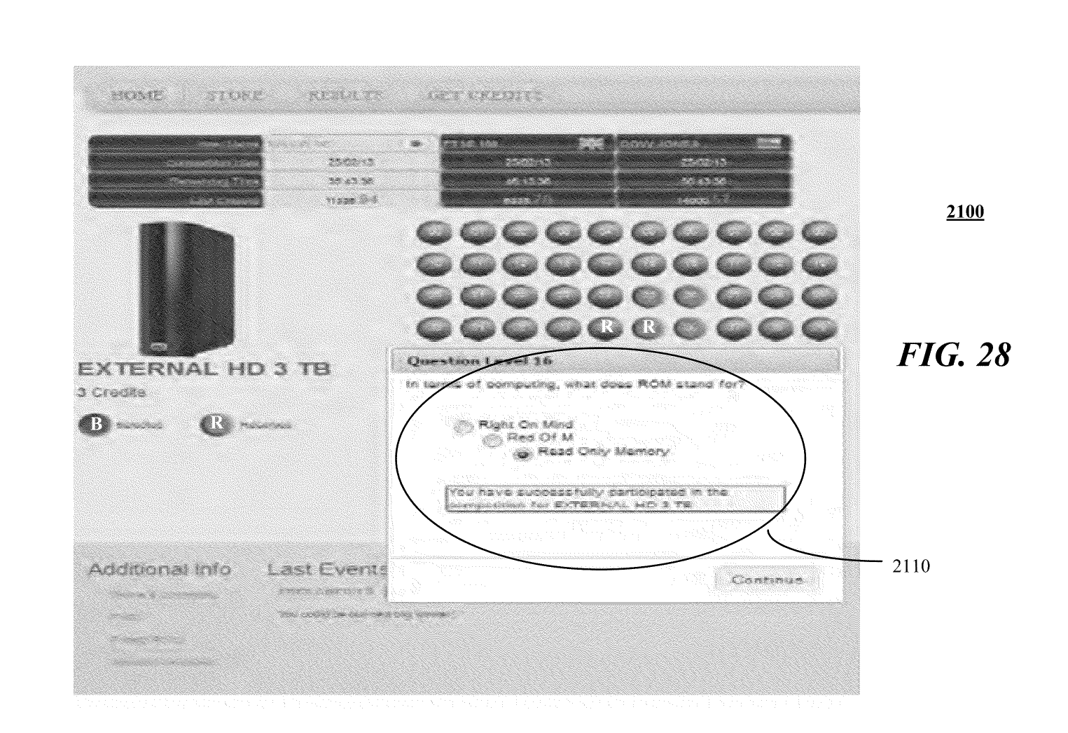

FIG. 28 is a UI screen 2100 of a follow up number entry by the second player seeking to add three new possible winning numbers (56, 57, 58) (not shown). Numbers 34, 35, 44, and 45 were automatically reserved when selected by the second player (not shown) in the same manner in which the first player selected the same numbers in relation to a different product (in a different competition). We can see in the section just above pop-up 2110 numbers 34, and 35 and see that they are labeled as reserved, which is correct since locked in the previous question-answering step (along with number 44 and 45, of course).

To reserve the additional numbers 56, 57, and 58, the second player is required to answer a second question and this is presented to him in the pop-up 2110. In response to the entry of new numbers and the correct answer having been selected in 2110, server 201 acknowledges and approves the request to add numbers.

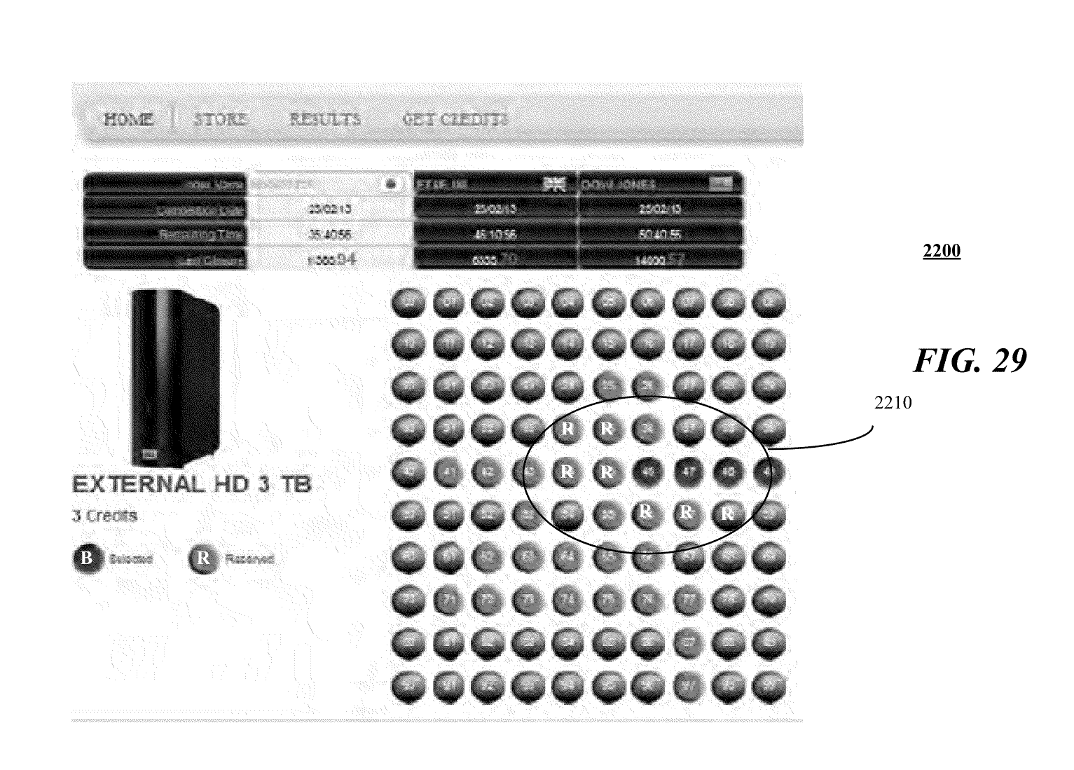

FIG. 29 is a UI screen 2200 generated by the server in response to the right answer, and showing subset of numbers 34, 35, 44, 45, 56, 57, and 58 all now being designated as reserved (red color).

For discussion purposes, we will consider what happens if the attempt to answer a question correctly had failed.

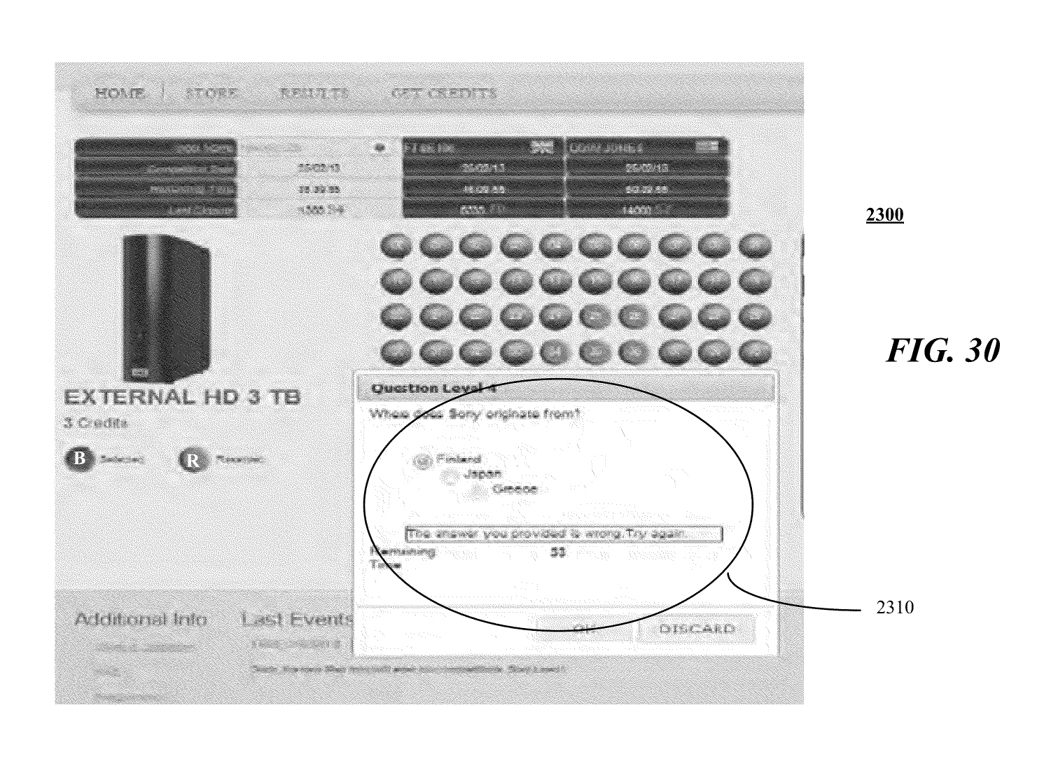

FIG. 30 is a UI screen 2300 of a pop up 2310 generated in response to the same player wanting to add the further three additional numbers 56, 57, and 58. This time, a different question is presented which the second player gets wrong).

Because the question was answered incorrectly, the player is taken back to the number selection UI. Here is afforded an opportunity to pick fewer new numbers (and hence be required a less difficult question) or to try again with a new question. The previously selected numbers are removed, except for those that were locked.

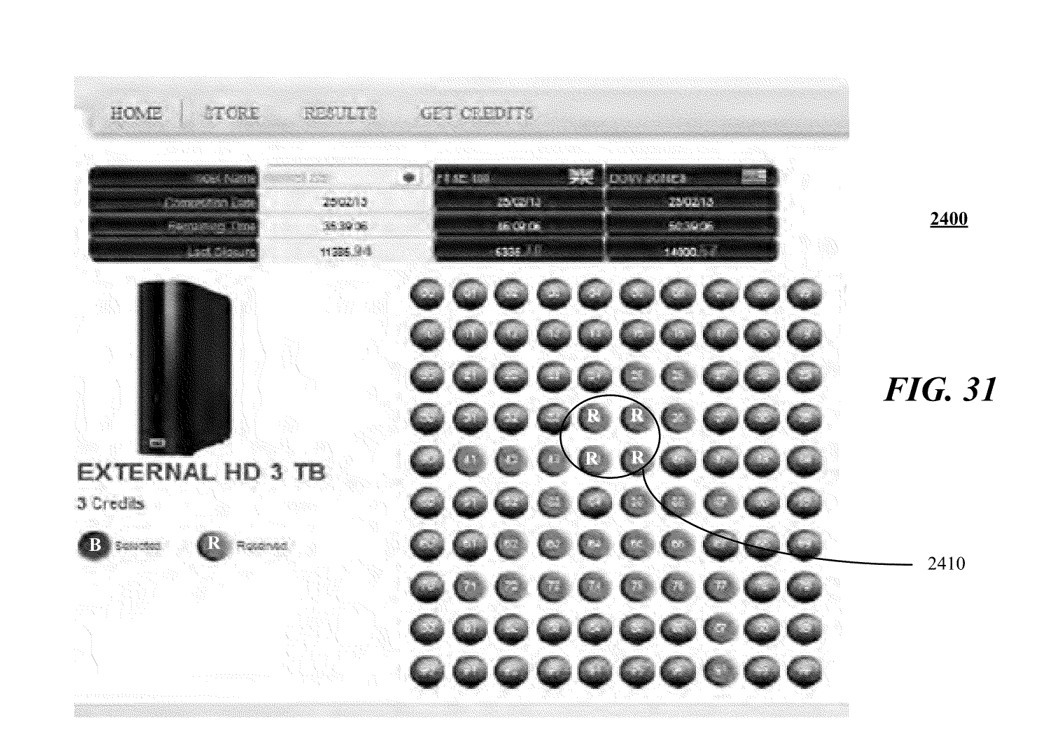

FIG. 31 is a UI screen 2400 which takes back the second player to the number-selection table to allow selection of new numbers and a new question. In the example shown, the originally reserved numbers for that player are still held for him since the first question was answered correctly. It is possible that they could have all become unreserved in response to any future questions having been answered incorrectly.

As mentioned above, one or more locked numbers may also be assigned “reserved” status to prevent anyone else from bidding on the same numbers, at least for that product. In this regard, the numbers shown as reserved, could instead be shown as reserved because selected by yet a third player who is simultaneously playing along in the same competition from a different client device. In this latter scenario, a proper designator would be provided to help players distinguish between reserved numbers associated with them and those associated with other players.

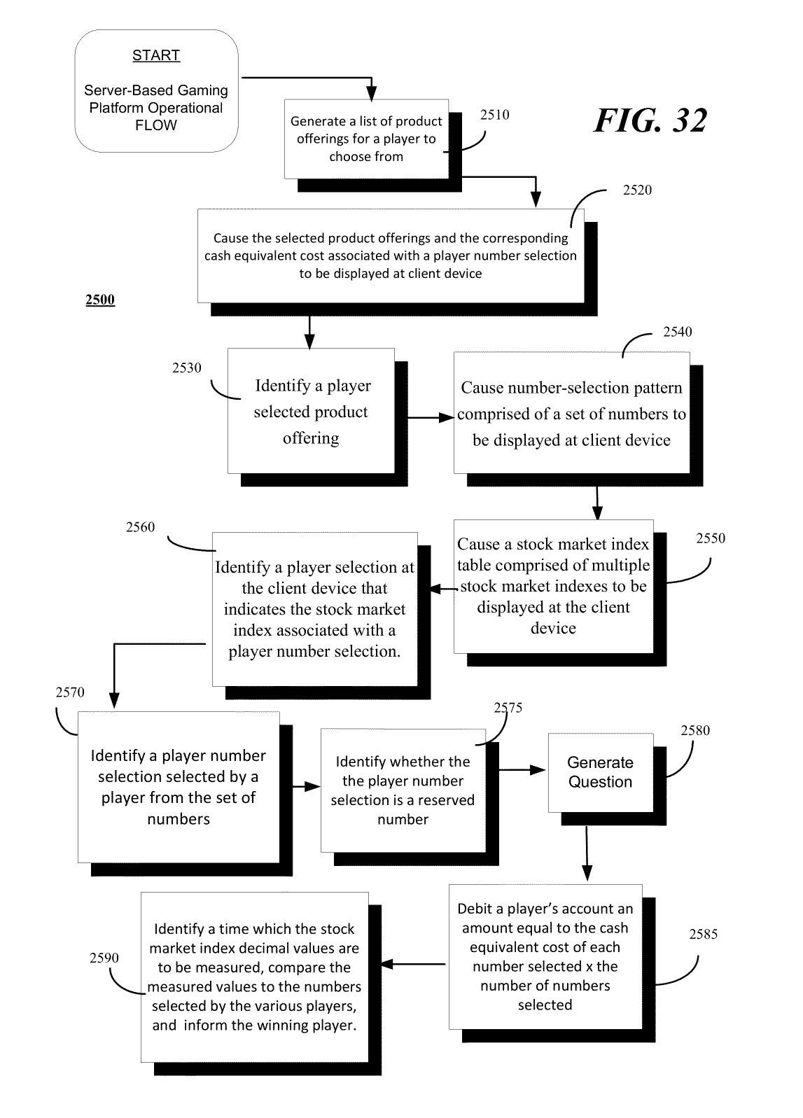

FIG. 32 is a high level operational flow diagram of routine 2500 running at the server-based gaming platform 199, in accordance with an exemplary embodiment.

As an initial step, the routine generate a list of product offerings for a player to choose from (2510). In a next step, the selected product offerings and the corresponding cash equivalent cost associated with a player number selection are generated for display at client device (2520). A player selected product offering is identified (2530) and a number-selection pattern comprised of a set of numbers is generated to be displayed at the client device (2540). A stock market index table comprised of multiple stock market indexes is then generated to be displayed at the client device (2550).

A player selection at the client device is then identified which indicates the stock market index associated with a player number selection (2560). At same time, a player number selection selected by a player from the set of numbers is identified (2570) and a comparison to a list of reserved numbers is made (2575). Before the numbers are accepted, a question may be generated (2580) which in one embodiment needs to be correctly answered. Assuming the answer is correct to the question, and the player's account has enough cash or cash equivalents to satisfy the draw down, the numbers chosen are accepted and reserved as against later players wanting the same number (unless more than one person is allowed to have a same number in the same competition). Once the numbers are accepted, the player's account is debited. In one scenario, the debit is an amount equal to the cash equivalent cost of each number selected×the number of numbers selected (2585).

The routine then monitors activities relating to the timing of when the relevant stock market index is to close, or the relevant time interval for a measurement to be taken is up. At that point, the stock market index decimal values are measured, compared to the numbers selected by the various players, and the winners (and losers) informed of the outcome (2590).

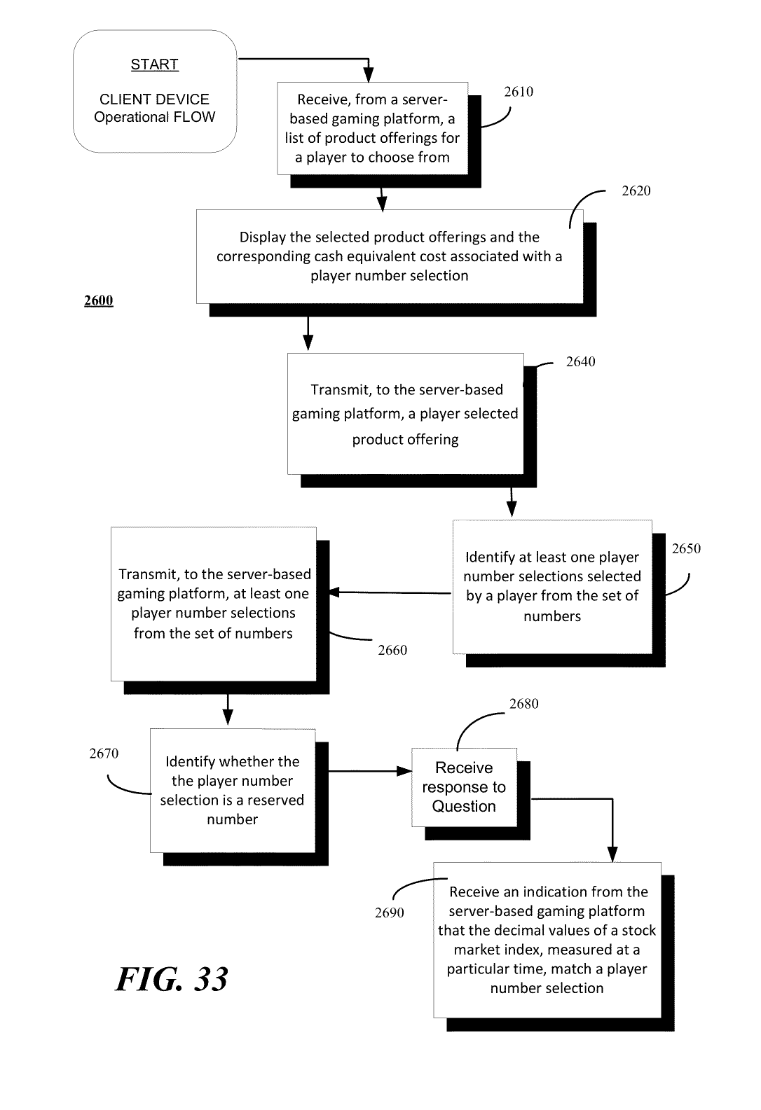

FIG. 33 is a further high level operational flow diagram of routine 2600 running in a client device, in accordance with an exemplary embodiment.

At step 2610, the client receives, from server-based gaming platform 199, a list of product offerings for a player to choose from. The selected product offerings and the corresponding cash equivalent cost associated with a player number selection are then displayed at a display interface, GUI or equivalent manner (2620). The client then transmits, back to server-based gaming platform 199, the player selected product offering (2640) and at least one player number selections made by the player out of the available set of numbers (2660). The client checks to verify that the player number selection is a reserved number (2670). In the case of a requirement to answer a question, the question is received from the server-based gaming platform and presented to the player to provide a response (2680).

Finally, at some point, the client will be notified from the gaming platform 199 that the decimal values of a stock market index, measured at a particular time, match a player number selection. Winners (and losers) will then be notified of the outcome and arrangements made to have the winning prize delivered to the winner (or winners if more than one were allowed to wager the same number.

It should be appreciated that the KENO numbering interface is simply described as an exemplary embodiment. Any equivalent wagering item, whether it be graphics, icons, animals, alphabetic characters, or any like alternative, is contemplated herein and may be employed in lieu of a KENO like UI with real numbers. Likewise the number of total wagering items can be some number other than 100.

Each such graphic or icon could have associated with a number so as to allow association of same with a selected stock exchange index. In another scenario, the graphics are horses in a horse race, or sports figures, or any other image, where a random number generator function can be applied (e.g., a baseball batting average at end of a game).

In yet a further embodiment, the stock index RNG function is merely an input to a RNG engine from which engine a winning image or icon is selected.

It should further be appreciated that outcome server 201 can comprise one physical server, or multiple such servers spread across one or more continents. In addition, the winning outcome may be determined at outcome server 201 exclusively, a player management server 200, 202, or by both sharing responsibilities. Player management servers manage member access, registration, profile and other information. In one aspect, the selection and/or function of generating questions, for survey or such other purposes as previously explained, are preferably performed at one or more management servers 200, 202.

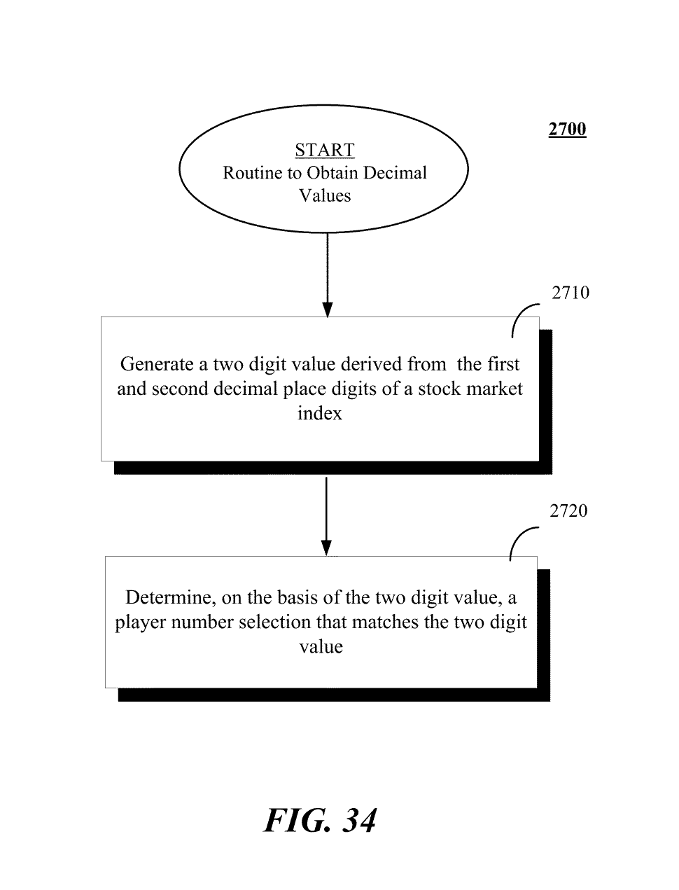

FIG. 34 are selected player numbers to the decimal values or sends it the values to be compared to selected numbers in a variety of number-based wagering competition platforms, and/or devices.

Various embodiments of the invention are described above in the Detailed Description. While these descriptions directly describe the above embodiments, it is understood that those skilled in the art may conceive modifications and/or variations to the specific embodiments shown and described herein.

Any modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings.

The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims. In another similar scenario, the game outcome server is part of a social network community platform such as Facebook, MySpace, or smaller communities, such as corporate communities of employees, common interest groups, and similar platforms.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. In a server-based gaming platform, a method of wagering comprising:
generating a list of product offerings for a player to choose from;
causing the selected product offerings and the corresponding cash equivalent cost associated with a player number selection to be displayed at a client device;
identifying a player selected product offering;
causing a number-selection pattern comprised of a set of numbers to be displayed at the client device;
identifying at least one player number selections selected by a player from the set of numbers;
identifying whether any of the at least one player number selections is a reserved number; and
debiting a player's account an amount equal to the cash equivalent cost of each number selected times the number of numbers selected.

2. The method of claim 1, further comprising causing a stock market index table comprised of multiple stock market indexes to be displayed at the client device.

3. The method of claim 1, further comprising identifying a player selection at the client device that indicates the stock market index associated with a player number selection.

4. The method of claim 3, further comprising identifying a time which the stock market index decimal values are to be measured, comparing the measured values to the numbers selected by the various players, and informing the winning player.

5. The method of claim 1, further comprising identifying reserved numbers and providing an indication to the player as to which numbers are not available to the player for selection.

6. The method of claim 1, further comprising generating a question, where the question must be answered correctly before the player number selections are approved.

7. The method of claim 6, further comprising generating a second question when a new number is selected in the same competition.

8. The method of claim 6, further comprising identifying a degree of difficulty and selecting a question on that basis.

9. The method of claim 1, wherein the cash equivalents are at least one of money, points or credits.

10. In a client device, a method of wagering comprising:
receiving, from a server-based gaming platform, a list of product offerings for a player to choose from;
displaying the selected product offerings and the corresponding cash equivalent cost associated with a player number selection;
transmitting, to the server-based gaming platform, a player selected product offering;
receiving, from the server-based gaming platform, a number-selection pattern comprised of a set of numbers;
transmitting, to the server-based gaming platform, at least one player number selections from the set of numbers; and
receiving an indication when at least one player number selections is a reserved number.

11. The method of claim 10, further comprising displaying a stock market index table comprised of multiple stock market indexes to be displayed at the client device.

12. The method of claim 10, further comprising identifying a player selection that indicates the stock market index associated with a player number selection.

13. The method of claim 12, further comprising receiving an indication from the server-based gaming platform that the decimal values of a stock market index, measured at a particular time, match a player number selection.

14. The method of claim 10, further comprising displaying reserved numbers.

15. The method of claim 10, further comprising displaying a question, where the question must be answered correctly before the player number selections are approved.

16. The method of claim 15, further comprising displaying a second question when a new number is selected in the same competition.

17. The method of claim 15, wherein the question is selected on the basis of a degree of difficulty.

18. The method of claim 10, further comprising displaying a stock market index table comprised of multiple stock market indexes, and identifying a player selection that indicates the stock market index associated with a player number selection.

19. The method of claim 10, wherein the cash equivalents are at least one of money, points or credits.

20. The method of claim 10, further comprising displaying the time interval at which the stock market index is to be measured for wagering purposes.

21. A server-based gaming platform configured for wagering by a player on a client device on a game of chance, comprising:
means for generating a list of product offerings for a player to choose from;
means for causing the selected product offerings and the corresponding cash equivalent cost associated with a player number selection to be displayed at a client device;
means for identifying a player selected product offering;
means for causing a number-selection pattern comprised of a set of numbers to be displayed at the client device;
means for identifying at least one player number selections selected by a player from the set of numbers;
means for identifying whether any of the at least one player number selections is a reserved number; and
means for debiting a player's account an amount equal to the cash equivalent cost of each number selected times the number of numbers selected.

22. The platform of claim 21, further comprising means for identifying a player selection at the client device that indicates the stock market index associated with a player number selection.

23. The platform of claim 22, further comprising means for identifying a time which the stock market index decimal values are to be measured, means for comparing the measured values to the numbers selected by the various players, and means for informing the winning player.

24. The platform of claim 21, further comprising means for identifying reserved numbers to provide an indication to the player at the client device as to which numbers are not available to the player for selection.

25. The platform of claim 21, further comprising means for generating a question, where the question must be answered correctly before the player number selections are approved.

26. A client device for wagering comprising:
means for receiving, from a server-based gaming platform, a list of product offerings for a player to choose from;
means for displaying the selected product offerings and the corresponding cash equivalent cost associated with a player number selection;
means for transmitting, to the server-based gaming platform, a player selected product offering;
means for receiving, from the server-based gaming platform, a number-selection pattern comprised of a set of numbers;
means for transmitting, to the server-based gaming platform, at least one player number selections from the set of numbers; and
means for receiving an indication when at least one player number selections is a reserved number.

27. The client device of claim 26, further comprising means for receiving an indication from the server-based gaming platform that the decimal values of a stock market index, measured at a particular time, match a player number selection.

28. The client device of claim 26, further comprising means for displaying reserved numbers.

29. The client device of claim 26, further comprising means for displaying a question, where the question must be answered correctly before the player number selections are approved.

30. A non-transitory computer program product for use by a server-based gaming platform configured to facilitate wagering by a player on a client device on a game of chance, the computer program product including instructions to:
generate a list of product offerings for a player to choose from;
cause the selected product offerings and the corresponding cash equivalent cost associated with a player number selection to be displayed at a client device;
identify a player selected product offering;
cause a number-selection pattern comprised of a set of numbers to be displayed at the client device;
identify at least one player number selections selected by a player from the set of numbers;
identify whether any of the at least one player number selections is a reserved number; and
debit a player's account an amount equal to the cash equivalent cost of each number selected times the number of numbers selected.

31. The computer program product of claim 30, further comprising an instruction to identify a player selection at the client device that indicates the stock market index associated with a player number selection.

32. The computer program product of claim 30, further comprising instructions to identify a time which the stock market index decimal values are to be measured, compare the measured values to the numbers selected by the various players, and inform the winning player.

33. A non-transitory computer program product for use by a client device configured for communication with a server-based gaming platform to facilitate wagering by a player, the computer program product including instructions to:
receive, from a server-based gaming platform, a list of product offerings for a player to choose from;
display the selected product offerings and the corresponding cash equivalent cost associated with a player number selection;
transmit, to the server-based gaming platform, a player selected product offering;
receive, from the server-based gaming platform, a number-selection pattern comprised of a set of numbers;
transmit, to the server-based gaming platform, at least one player number selections from the set of numbers; and
receive an indication when at least one player number selections is a reserved number.

34. The computer program product of claim 33, further comprising instructions to receive an indication from the server-based gaming platform that the decimal values of a stock market index, measured at a particular time, match a player number selection.

35. In a server-based gaming platform, a method of generating random numbers, in connection with game of chance competitions, comprising:
generating a two digit value derived from the first and second decimal place digits of a stock market index; and
determining, on the basis of the two digit value, a player number selection that matches the two digit value.

36. A server-based gaming platform for generating random numbers in connection with game of chance competitions, comprising:
means for generating a two digit value derived from the first and second decimal place digits of a stock market index; and
means for determining, on the basis of the two digit value, a player number selection that matches the two digit value.

37. A non-transitory computer program product for causing a server-based gaming platform to generate random numbers in connection with game of chance competitions, the computer program product having instructions to:
generate a two digit value derived from the first and second decimal place digits of a stock market index; and
determine, on the basis of the two digit value, a player number selection that matches the two digit value.
